(19) United States
(12) Patent Application Publication
(10) Pub. No.: US 2012/0165174 A1
(43) Pub. Date: Jun. 28, 2012

(54) SINGLE WEB SINGLE-FOLD APPARATUS AND METHOD

(75) Inventor: Tad T. Butterworth, Ashland, WI (US)

(73) Assignee: C.G. BRETTING MANUFACTURING CO., INC., Ashland, WI (US)

(21) Appl. No.: 12/977,393

(22) Filed: Dec. 23, 2010

(51) Int. Cl. B31B 1/26

(52) U.S. Cl. 493/451; 493/405

(57) ABSTRACT

A folding apparatus and method are provided for producing a single-folded pattern of interfolded sheets from a single web of material, through the use of a sheet cutting and directing arrangement having a sheet crossover arrangement. Some embodiments are operable in a variety of modes, with one or two webs of material, to produce either single-fold or multi-fold patterns of interfolded sheets. Some embodiments include a sheet cutting arrangement inside of the sheet cutting and directing arrangement for selectively producing sheets of various lengths.

### FIELD OF THE INVENTION

This invention generally relates to folding one or more webs of material into a stream of folded sheet products, such as hand towels, in a variety of folding arrangements with the same folding apparatus, and more particularly to producing single-fold product from a single web of sheet material rather than from two webs of material.

### BACKGROUND OF THE INVENTION

A variety of types of machines and processes exist for making folded paper products such as towels and the like by producing stacks of interfolded sheets, or non-interfolded sheets, having a desired folded width.

In the simplest form of a folded sheet, each sheet is folded only once to form double-panel sheets having two panels joined along a common fold line. One popular multi-panel interfolded pattern has three successive identical panels joined along two fold lines to form a Z-folded shape. Another popular pattern has four successive identical panels having a W-folded shape. Other folded shapes and numbers of panels are also commonly used.

It is often desirable to interfold one or more panels of successive sheets, at the same time as the sheets are being folded, by partially overlapping the individual sheets in the stack during the folding process. The overlapping and folding is carried out in such a manner that, with the interfolded stack loaded into a dispenser, when a sheet is pulled out of the dispenser at least one panel of the following sheet is also pulled out of the dispenser to facilitate pulling the next sheet from the dispenser.

The number of panels in each sheet, and the number of panels of each sheet to be overlapped in a desired interfolding pattern is a matter of choice by the manufacturer, to meet a particular customer need, and to work well in a particular type of dispenser. In the past, folded sheet manufacturers have also typically been undesirably limited to only certain folding and interfolding patterns that could be produced using the equipment and processes available in their respective manufacturing facilities for producing the stacks of interfolded sheets.

In one commonly used form of prior interfolding apparatuses and methods, interfolded stacks of sheets are formed from one or more webs of material fed through the nip formed between counter-rotating folding rolls rotating at the same speed. A fundamental characteristic of such machines and methods using counter-rotating folding rolls is that each successive fold in the sheet streams passing through the nip is oriented in the opposite direction. Prior machines and methods of this type have been limited by their construction and operational characteristics to either exclusively producing so-called “single-fold” interfolded products, or to producing exclusively so-called “multi-fold” interfolded products.

The exact definitions and origins of the “single-fold” and “multi-fold” terminology have long been lost in antiquity. It is believed, however, that the terms emerged over time with entry into the marketplace of different interfolding patterns. Originally, double-panel sheets having only two panels were interfolded in a V-shape (see FIG. 1A) from two parallel streams of cut sheets having the leading and trailing edges of successive sheets in one sheet stream offset from the leading and trailing edges of the successive sheets in the second sheet stream by one panel, in the manner indicated in FIG. 1B. Machines, methods and products formed using parallel sheet streams came to be known as “single-fold” machines, methods and products.

When it became desirable to provide an interfolded stack of three-panel, Z-shaped sheets with only the last panel of one sheet overlapped with only the first panel of the next sheet in the stream (see FIG. 2A), however, single-fold equipment and methods using parallel sheet streams were inherently incapable of producing such a pattern. It was found that a sheet stream cut from a single web of material and having adjacent sheets overlapped in a “shingled” pattern, as shown in FIG. 2B was required, to form the desired interfolded stack of three-panel, Z-shaped sheets with only a trailing panel of one sheet overlapped with only the leading panel of the next sheet, as shown in FIG. 2B. Machines, methods and products formed using such single-web, shingled sheet streams came to be known as “multi-fold” machines, methods and products.

Multi-fold machines and methods are inherently incapable of producing single-fold products, and vice-versa. In both single-fold and multi-fold machines and methods it has typically also been necessary to physically change components in the sheet cutting and directing arrangement 116 in order to deal with variations in sheet lengths, even where the panels are of equal width in the different length sheets.

Over time, interfolding patterns other than the basic V-shaped and Z-shaped sheets with a single panel overlapped with adjacent sheets emerged, having more panels in the sheets and more than one panel overlapped with adjacent sheets. These folding patterns continued to typically be classified as either single-fold patterns or as multi-fold patterns, however, depending upon whether two parallel streams of sheets, or a single shingle-overlapped stream of sheets was fed through the nip between the folding rolls to form the desired patterns. For example, as shown in FIG. 10B, W-shaped four-panel sheets overlapped by only one panel with adjacent sheets must be formed from two parallel sheet streams and are thus single-fold products. Conversely, W-shaped four-panel sheets overlapping adjacent sheets by two panels, must be formed from a single stream of sheets overlapped in a shingled pattern, as shown in FIG. 12B, and are thus multi-folded products.

Throughout the disclosure and claims herein describing the present invention, the traditional meaning of the terms “single-fold” and “multi-fold,” as defined above, is utilized. “Single-fold” machinery, methods and products are those that have traditionally required two parallel sheet streams. “Multi-fold” machinery, methods and products are those that have traditionally required a single stream of sheets overlapped in a shingle-like pattern before passing through the nip between the folding rolls.

Prior single-fold interfolding machines and methods are exemplified by the disclosures of U.S. Pat. No. 7,306,554 and 7,458,927. Such prior single-fold interfolding machines producing single-folded products generally operate in the manner indicated schematically in attached FIG. 3. Specifically, a pair of first and second webs 102, 104 are fed into a sheet feeding and cutting arrangement 106, which alternately cuts individual sheets from the first and second webs 102, 104 and feeds the sheets in an alternating sequence in two parallel sheet streams, as shown in FIG. 1B, into a nip 108 between a pair of first and second interfolding rolls 110, 112 to form a stack 114 of single-folded sheets. With such an arrangement, it is typically necessary to make physical changes to the hardware within the sheet feeding and cutting arrangement 106 in order to change the length of the folded sheets. The width of individual folded panels of the sheets is essentially set by the spacing between gripping and folding elements spaced around the periphery of the interfolding rolls 110, 112. Accordingly, to change panel size or sheet length, different sized rolls must be used.

Prior multi-fold machines and methods are exemplified by the machines and methods disclosed in U.S. Pat. No. 7,452,321 in which only a single web 102 of material is feed through a sheet cutting and directing arrangement 116, in the manner indicated schematically in FIG. 4, to feed a stream of sheets cut from a single web 104 and overlapped in a shingle-like pattern, as shown in FIG. 2B, through the nip 108 between the folding rolls 110, 112 to form a multi-folded pattern 118 of interfolded sheets. With the arrangement shown in FIG. 4, it is still generally necessary to physically change components in the sheet cutting and directing arrangement 116 in order to deal with variations in sheet lengths, even where the panels are of equal width in the different length sheets.

Commonly assigned U.S. Pat. No. 7,717,839, illustrated schematically in FIG. 5, shows a more recent multi-fold approach in which the necessity for physically changing components in the sheet cutting and directing arrangement 116 in order to deal with a variety of sheet lengths having panels of equal width effectively combines two sheet cutting and directing arrangements 116A, 116B with a common set of folding rolls 110, 112 in the manner illustrated in FIG. 3. With this arrangement, each of the respective first and second sheet cutting and directing arrangements 116A, 116B includes components configured to cut and overlap successive sheets in a manner required to provide a first multi-folded pattern 120 from a first web 102, or alternatively a second multi-folded pattern 122 from a second web of material 104. With this arrangement, the material is fed from only one side at a time, (i.e. either exclusively from the first web 102 or alternatively exclusively from the second web 104), and only the sheet cutting and directing arrangement 116A or 116B associated with the respective first or second webs 102, 104 feeding the web material is operated at any given time, with the other sheet cutting and directing arrangement remaining idle.

With an arrangement or method according to the U.S. Pat. No. 7,717,839, for example, one of the sheet cutting and directing arrangements 116A may be configured to provide a first interfolded pattern 120 having sheets of three panels in length overlapping one another by a single panel, whereas the second sheet cutting and directing arrangement 116B may be configured to form a second desired interfolded pattern 122 having a sheet length of four panels with successive sheets overlapping one another by two panels. In this manner, a single machine may be very rapidly converted to producing either one of the two interfolded patterns 120, 122, without making any physical changes inside of the machine other than threading the appropriate first or second webs 102, 104 through the appropriate side of the machine.

Commonly assigned U.S. Pat. No. 6,296,601 provides an apparatus and method in which the circumferential spacing between cutting blades in a vacuum roll can be conveniently changed without physical replacement of machine components and, in some embodiments without shutting down the machine. Although such innovations work well in some machines and methods, additional improvement is still desirable to provide additional flexibility in production of folded products.

In light of the above summarized limitations of prior single-fold and multi-fold machines and methods, it is desirable to provide an improved folding apparatus and method for producing a single-folded pattern, similar to a pattern produced by the machine shown in FIG. 1, but without having two webs feeding into the machine. It is also desirable that such an improved apparatus and method be operable in a variety of modes, with one or two webs of material, to produce either single-fold or multi-fold configurations similar to those which might be produced in any of the machines shown in FIGS. 3-5. It is further desirable, that in some embodiments of such an improved apparatus and method, an enhanced sheet cutting arrangement inside of the sheet cutting and directing arrangement 124 be capable of selectively producing sheets of various lengths, without the need for changing components in the manner typically required in present-day interfolding equipment.

### BRIEF SUMMARY OF THE INVENTION

An improved folding apparatus and method are provided for producing a single-folded pattern of interfolded sheets from a single web of material, through the use of a sheet cutting and directing arrangement having a sheet crossover arrangement. Some forms of the invention are operable in a variety of modes, with one or two webs of material, to produce either single-fold or multi-fold patterns of interfolded sheets. Some forms of the invention are also operable in a zig-zag folding mode, to produce a zig-zag fold pattern. Some forms of the invention include a variable length sheet cutting arrangement inside of the sheet cutting and directing arrangement for selectively producing sheets of various lengths.

In one form of the invention, a folding apparatus for forming a pattern of single-folded sheets from a single web of material is provided. The folding apparatus includes a pair of counter-rotating first and second folding rolls and a sheet cutting and directing arrangement. The pair of counter-rotating first and second folding rolls forms a nip therebetween for passage through the nip of at least one stream of sheets. The sheet cutting and directing arrangement is configured for operation in a single-fold mode, for cutting and directing successive sheets cut from the single web of material alternatively along first and second paths extending through the nip in two parallel streams of sheets to produce the single-folded pattern of interfolded sheets.

The sheet cutting and directing arrangement, in some forms of the invention, may also be configured for operation alternatively in a multi-fold mode in which the sheet cutting and directing arrangement directs all of the successive sheets through the nip in a single stream of sheets with the successive sheets overlapped in a shingle-like orientation. In some forms of the invention, such a sheet cutting and directing arrangement may be configured for operation in either a first or a second multi-fold mode of operation.

In a first multi-fold mode of operation, according to the invention, all of the successive sheets may be directed into a single stream of successive sheets entering the nip along only the first path and passing through the nip with successive sheets overlapped in a shingle-like manner to produce a first multi-folded pattern of interfolded sheets. A second multi-fold mode of operation, according to the invention, may include directing all of the successive sheets into a single stream of successive sheets entering the nip along only the second path and passing through the nip with successive sheets overlapped in a shingle-like manner to produce a second multi-folded pattern of interfolded sheets. The first and second multi-folded patterns of interfolded sheets may be identical or different multi-folded patterns in various forms of the invention. Some forms of the invention may be configured for operation only in a first multi-fold mode of operation. Other forms of the invention may be configured for operation only in a second multi-fold mode of operation. Some forms of the invention may be configured for operation in either a first or a second multi-fold mode of operation.

In some forms of the invention, the sheet cutting and directing arrangement may be further configured for operation alternatively in a zig-zag fold mode in which the sheet cutting and directing arrangement directs a length of the single web of material through the nip without cutting the length of web into successive sheets, to thereby form a zig-zag fold pattern having a length of the single web of material folded to form a plurality of panels joined to one another along common fold lines disposed between adjacent panels.

In some forms of the invention, a cutting and directing arrangement may be further configured for alternatively receiving a first and a second web of material, and for operation alternatively in a dual-web alternate single fold mode. When operating in such a dual-web alternate single-fold mode, the cutting and directing arrangement cuts and directs successive sheets from the first and second webs of material along first and second paths extending through the nip in the two parallel streams of sheets to produce the single-folded pattern of interfolded sheets.

In some forms of the invention, the sheet cutting and directing arrangement directs the successive sheets through the nip in an overlapped manner by transporting the overlapped sheets to the nip with an overlapped sheet conveying arrangement. The sheet cutting and directing arrangement, in some forms of the invention, includes a variable cut-off arrangement for selectively producing one of two or more different lengths of successive sheets.

In some forms of the invention, the sheet cutting and directing arrangement includes a sheet crossover arrangement for directing every other one of the successive sheets cut from the single web of material alternately down the first and second paths through the nip.

The cutting and directing arrangement, in some forms of the invention, may include a knife roll for cutting the web into successive sheets, a primary lap roll, and a secondary lap roll with the primary and secondary lap rolls each being operatively disposed for directing the successive sheets of the folding rolls. Such a cutting and directing arrangement may further include a sheet crossover arrangement having a sheet crossover roll for receiving alternating ones of the successive sheets from the knife roll and directing the alternating ones of the successive sheets to the secondary lap roll, in such a manner that a first stream of the two parallel sheet streams comprising alternating ones of the successive sheets travels along the first path through the nip by being transferred sequentially from the knife roll, to the primary lap roll, to the first folding roll of the pair of folding rolls, while a second stream of the parallel sheet streams comprising every other alternating one of the successive sheets travels along the second path through the nip by being transferred sequentially from the knife roll, to the crossover roll, to the secondary lap roll, to the second folding roll of the pair of folding rolls. In some forms of the invention, the sheets are respectively transferred directly from the primary lap roll to the first folding roll and directly from the secondary lap roll to the second folding roll. In other forms of the invention, the sheet cutting and directing arrangement further includes a conveying arrangement disposed downstream from the primary and secondary lap rolls, and the sheets are transferred indirectly from the primary and secondary lap rolls to the folding rolls by the conveying arrangement.

Forms of the invention including a sheet crossover roll may also include a variable cut-off arrangement in the sheet cutting and directing arrangement for selectively producing one of two or more different predetermined lengths of successive sheets.

In some forms of the invention having a primary and secondary lap roll and a crossover roll, the primary and secondary lap rolls and the crossover roll are all rotatable about respective axes thereof, with the respective axes all extending substantially parallel to one another. The crossover roll axis may be moveable with respect to at least one of the axes of the primary and secondary lap rolls between at least a first and a second position of the crossover roll. A first position of the crossover roll may correspond to a first predetermined sheet length, and a second position of the crossover roll may correspond to a second sheet length.

In some forms of the invention, a variable cut-off arrangement may include a knife roll. In other forms of the invention, cut-off arrangements not including a knife roll may be utilized.

The crossover roll, in some forms of the invention, may be selectively disengagable for operation in a multi-fold mode of operation wherein all of the successive sheets are transferred from the knife roll to only one of the primary and secondary lap rolls, to thereby form a single stream of successive sheets entering the nip along only one of the first and second paths and passing through the nip with successive sheets overlapped in a shingle-like manner to produce a multi-folded pattern of interfolded sheets.

Some forms of the invention may include both a disengagable crossover roll and a variable cut-off arrangement having a knife roll. The crossover roll may be disengagable for operation in a first multi-fold mode of operation wherein all of the successive sheets are transferred from the knife roll to the primary lap roll to form a single stream of successive sheets entering the nip along only the first path and passing through the nip with successive sheets overlapped in a shingle-like manner to produce a first multi-folded pattern of interfolded sheets.

In some forms of the invention having a disengagable crossover roll and a knife roll, the crossover roll is not disengaged during operation in a second multi-fold mode of operation wherein all of the successive sheets are transferred by the crossover roll from the knife roll to the secondary lap roll, to thereby form a single stream of successive sheets entering the nip along only the second path and passing through the nip with successive sheets overlapped in a shingle-like manner to produce a second multi-folded pattern of interfolded sheets.

The invention may take the form of a method for forming a pattern of single-folded sheets from a single web of material using a pair of counter-rotating first and second folding rolls forming a nip therebetween for passage through the nip of at least one stream of sheets. In such a method, the single web of material may be fed to a sheet cutting and directing arrangement configured for cutting and directing successive sheets cut from the single of material alternatively along first and second paths extending through the nip and two parallel streams of sheets to produce the single-folded pattern of interfolded sheets. The successive sheets are cut from the single web of material with the sheet cutting and directing arrangement. The sheet cutting and directing arrangement then directs the successive sheets cut from the single web of material alternatively down first and second paths extending through the nip in two parallel streams of sheets in a single-fold mode of operation to produce the single-folded pattern.

A method, according to the invention, may also include operating the sheet cutting and directing arrangement in a multi-fold mode of operation to produce a multi-folded pattern having the successive sheets overlap in a shingle-like orientation. Some forms of a method, according to the invention, may include operating the sheet cutting and directing arrangement alternatively in either a first multi-fold mode of operation to produce a first multi-folded pattern having the successive sheets overlapped in a shingle-like orientation, or a second multi-fold mode of operation having the successive sheets overlapped in a shingle-like manner to produce a second multi-folded pattern of interfolded sheets.

Some forms of the method, according to the invention, may further include operating a sheet cutting and directing arrangement, according to the invention, in a zig-zag fold mode of operation to produce a zig-zag folded pattern having a length of the single web of material folded to form a plurality of panels joined to one another along common fold lines disposed between adjacent panels.

A method, according to the invention, may also include alternatively operating the sheet cutting and directing arrangement in a dual-web alternate single-fold mode of operation in which the sheet cutting and directing arrangements cut and directs successive sheets from two webs of material through the nip in two parallel streams of sheets to form the single-folded pattern.

In some forms of a method for operating the sheet cutting and directing arrangement in a dual-web alternate single-fold mode, where the cutting and directing arrangement includes first and second knife rolls for cutting the first and second webs, respectively, into first and second streams of successive sheets, a primary lap roll and a secondary lap roll each operatively disposed for directing the first and second streams of successive sheets to the folding rolls, a sheet crossover arrangement of the cutting and directing arrangement may be operated with the crossover roll disengaged during dual web alternate single-fold mode operation. With the crossover roll disengaged, the sheet crossover arrangement is configured in such a manner that the first stream of parallel sheet streams travels along the first path through the nip by being transferred sequentially from the first knife roll, to the primary lap roll, to the first folding roll of the pair of folding rolls, while the second stream of parallel sheet streams travels along the second path through the nip by being transferred sequentially from the second knife roll, to the secondary lap roll, and then to the second folding roll of the pair of folding rolls.

A method, according to the invention, may also include directing the successive sheets through the nip in an overlapped manner using a conveying arrangement for conveying the overlapped sheets to the nip. A method, according to the invention, may also include utilizing a variable cut-off arrangement of a sheet cutting and directing arrangement, according to the invention, for selectively producing one of two or more different lengths of successive sheets by cutting the web to one of the two or more sheet lengths.

In some forms of a method, according to the invention, a sheet crossover arrangement may be utilized in the single-fold mode of operation for directing every other one of the successive sheets cut from the single web of material alternately down the first and second paths through the nip. Such forms of a method may also include operating a variable cut-off arrangement of a sheet cutting and directing arrangement, according to the invention, for cutting the single web of material into successive sheets having one of two or more predetermined lengths of the successive sheets.

A method, according to the invention, may also include operating a sheet crossover arrangement for receiving on a crossover roll of the crossover arrangement alternating ones of the successive sheets from a knife roll and directing the alternating ones of the successive sheets to the secondary lap roll, in such a manner that a first stream of the parallel sheet streams comprises alternating ones of the successive sheets traveling along the first path through the nip by being transferred sequentially from the knife roll, to the primary lap roll, to the first folding roll of the pair of folding rolls. In such a method, the second stream of parallel sheet streams comprises every other alternating one of the successive sheets traveling along the second path through the nip by being transferred sequentially from the knife roll, to the crossover roll, to the secondary lap roll, to the second folding roll of the pair of folding rolls. Such a method may further include transferring the sheets directly from the primary lap roll to the first folding roll and directly from the secondary lap roll to the second folding roll. In other forms of such a method, the sheets may be transferred indirectly from the primary and secondary lap rolls to the folding rolls using a conveying arrangement operatively disposed downstream from the primary and secondary lap rolls.

A method, according to the invention, may also include disengaging a crossover roll for operation in a first multi-fold mode of operation wherein all of the successive sheets are transferred from a knife roll to the primary lap roll to form a single stream of successive sheets entering the nip along only the first path and passing through the nip with successive sheets overlapped in a single-like manner to produce a first multi-folded pattern of interfolded sheets.

The crossover roll in not disengaged, when operating in a second multi-fold mode of operation according to some forms of the invention, so that all of the successive sheets are transferred by the crossover roll from the knife roll to the secondary lap roll to form a single stream of successive sheets entering the nip only along the second path and passing through the nip with successive sheets overlapped in a shingle-like manner to produce a second multi-folded pattern of interfolded sheets.

In some methods, according to the invention, a sheet cutting and directing arrangement is operated in a zig-zag folding mode to form a zig-zag folded pattern. A sheet crossover arrangement of the sheet cutting and directing arrangement is configured to direct successive sheets along only one of the first and second paths during operation in the zig-zag folding mode. The sheet cutting and directing arrangement directs a length of the single web of material through the nip without cutting the length of web into successive sheets to form the zig-zag fold pattern, where the zig-zag fold pattern has the length of the single web of material folded to form a plurality of panels joined to one another along common fold lines disposed between adjacent panels.

The invention may take the form of a folding apparatus for alternatively forming either a single-fold or a multi-fold pattern of interfolded sheets from a single web of material. Such a folding apparatus may include a pair of counter-rotating folding rolls, and a sheet cutting and directing arrangement, according to the invention. The pair of counter-rotating folding rolls forms a nip therebetween for passage through the nip of at least one stream of the sheets, for folding the sheets. The sheet cutting and directing arrangement is configured for cutting and directing successive sheets cut from the single web of material through the nip between the folding rolls. The sheet cutting and directing arrangement is further configured for operation in a single-fold mode in which the sheet cutting and directing arrangement directs the successive sheets through the nip in two parallel streams of sheets. The sheet cutting and directing arrangement is also configured for operation alternatively in a multi-fold mode in which the sheet cutting and directing arrangement directs the successive sheets through the nip in a single stream of sheets with the successive sheets overlapped in a shingle-like orientation.

A folding apparatus for alternatively forming either a single-fold or a multi-fold pattern of interfolded sheets from a single web of material may include a cutting and directing arrangement which is further configured for operation in a zig-zag fold mode in which the sheet cutting and directing arrangement directs a length of the single web of material through the nip without cutting the length of web into successive sheets to form a zig-zag fold pattern having the length of the single web of material folded to form a plurality of panels joined to one another along common fold lines disposed between adjacent panels.

A folding apparatus, according to the invention, for alternatively forming either a single-fold or a multi-fold pattern of interfolded sheets from a single web of material may include a sheet cutting and directing arrangement which is further configured for operation in an alternate single-fold mode in which the sheet cutting and directing arrangement cuts and directs successive sheets cut from two webs of material through the nip into parallel streams of sheets.

A folding apparatus, according to the invention, for alternatively forming either a single-fold or a multi-fold pattern of interfolded sheets from a single web of material may include a sheet cutting and directing arrangement configured for operation in either a first multi-fold mode of operation, in a second multi-fold mode of operation, or in both a first and a second multi-fold mode of operation. For operation in such a first multi-fold mode, the sheet cutting and directing arrangement may be configured such that all of the successive sheets are directed into a single stream of successive sheets entering the nip along only the first path and passing through the nip with successive sheets overlapped in a shingle-like manner to produce a first multi-folded pattern of interfolded sheets. For operation in such a second multi-folded pattern, the sheet cutting and directing arrangement may be configured for alternatively directing all of the successive sheets into a single stream of successive sheets entering the nip only along the second path and passing through the nip with successive sheets overlapped in a shingle-like manner to produce a second multi-folded pattern of interfolded sheets.

The cutting and directing arrangement, in a folding apparatus for alternatively forming either a single-fold or a multi-fold pattern of interfolded sheets from a single web of material, according to the invention, may also be configured for receiving a first and a second web of material and operating alternatively in a dual-web alternate single-fold mode for cutting and directing successive sheets cut from the first and second webs of material along first and second paths extending through the nip and the two parallel streams of sheets to produce the single-folded pattern of interfolded sheets.

The invention may also take the form of a method for operating a folding apparatus configured for alternatively forming either a single-fold or a multi-fold pattern of interfolded sheets from a single web of material. Such a method may further include operating such a folding apparatus in additional folding modes, such as: a first multi-fold mode; a second-fold mode; a zig-zag fold mode; and/or a dual-web alternate single-fold mode.

Other aspects, objects and advantages of the invention will be apparent from the following detailed description and accompanying drawings.

### BRIEF DESCRIPTION OF THE DRAWINGS

The accompanying drawings incorporated into and forming a part of the specification illustrate several aspects of the present invention and, together with the description, serve to explain the principles of the invention. In the drawings:

FIG. 1A shows a single-fold, interfolded pattern of V-shaped sheets formed, in accordance with the prior art, from two parallel sheet streams as illustrated in FIG. 1B.

FIG. 1B illustrates two parallel sheet streams, according to the prior art, used in a folding apparatus having a pair of counter-rotating folding rolls to form the single-fold pattern of FIG. 1A.

FIG. 2A shows a multi-fold, interfolded pattern of Z-shaped sheets formed, in accordance with the prior art, from a single stream of sheets overlapped in a shingle-like manner as shown in FIG. 2B.

FIG. 2B shows a stream of sheets overlapped in a shingle-like pattern used, in accordance with the prior art, to form the multi-fold interfolded pattern of FIG. 2A when the sheet stream of FIG. 2B is fed through the nip between a pair of counter-rotating folding rolls of a folding apparatus.

FIG. 3 is a schematic illustration of a prior approach to forming a single-fold pattern of interfolded sheets from two webs of material.

FIG. 4 is a schematic illustration of a prior approach to forming a multi-fold pattern of interfolded sheets from a single web of material.

FIG. 5 is a schematic illustration of a prior approach to forming two different multi-fold interfolded patterns in a single folding apparatus from a single web of material fed into opposite sides of the apparatus and fed in a shingle-like overlapped stream of sheets through the nip between a single set of folding rolls.

FIG. 6 is a schematic illustration of a first exemplary embodiment of the invention for forming a single-fold pattern of interfolded sheets from a single web of material.

FIG. 7 is a more detailed schematic illustration of the exemplary embodiment of the invention shown in FIG. 6, illustrating internal components of a sheet cutting and directing arrangement of one exemplary embodiment of the invention.

FIGS. 8A-8C illustrate the manner of using the exemplary embodiment of FIGS. 6 and 7 to produce a single-fold pattern of interfolded V-shaped sheets.

FIGS. 9A-9C illustrate the manner of using the exemplary embodiment of FIGS. 6 and 7 to produce a single-fold pattern of interfolded W-shaped sheets having four panels joined at three common fold lines and adjoining sheets by one panel.

FIGS. 10A-10C illustrate the manner of using the exemplary embodiment of FIGS. 6 and 7 to produce a single-fold pattern of interfolded W-shaped sheets having four panels joined at three common fold lines and overlapping having three panels of adjoining sheets overlapping.

FIGS. 11A-11C illustrate the manner in which the exemplary embodiment of FIGS. 6 and 7 may be utilized for forming a multi-fold pattern of interfolded Z-shaped sheets having three panels joined at two common fold lines with adjacent sheets having one panel overlapping.

FIGS. 12A-12C illustrate the manner in which the exemplary embodiment of FIGS. 6 and 7 may be utilized for forming a multi-fold pattern of interfolded W-shaped sheets having four panels joined at three common fold lines with adjacent sheets overlapping one another by two panels with a crossover roll of the exemplary embodiment disables using a primary lap roll of the exemplary embodiment for interfolding the W-shaped sheets.

FIGS. 13A-13C illustrate a second manner in which the exemplary embodiment of FIGS. 6 and 7 may be utilized for forming a multi-fold pattern of interfolded W-shaped sheets having four panels joined at three common fold lines with adjacent sheets overlapping one another by two panels using a crossover roll and a secondary lap roll of the exemplary embodiment for interfolding the W-shaped sheets.

FIGS. 14A-14C illustrate the manner in which the exemplary embodiment shown in FIGS. 6 and 7 may be utilized for form an off-fold, single-fold, interfolded pattern of J-shaped sheets having a short lead panel overlapping a longer trailing panel of the preceding sheet.

FIGS. 15A-15C illustrate the manner in which the exemplary embodiment of FIGS. 6 and 7 may be utilized in a zig-zag fold mode to form a zig-zag pattern having multiple panels.

FIG. 16 illustrates a second exemplary embodiment of a folding apparatus, according to the invention, having a conveying arrangement disposed between lap rolls and folding rolls of the arrangement.

FIG. 17 is a schematic illustration of a third exemplary embodiment of a folding apparatus according to the invention, with the third exemplary embodiment having additional capability for producing a single-fold interfolded pattern from either a single web or two webs of material, and also capability for producing a multi-fold pattern from a single web of material, and further having the flexibility to produce a zig-zag folded pattern.

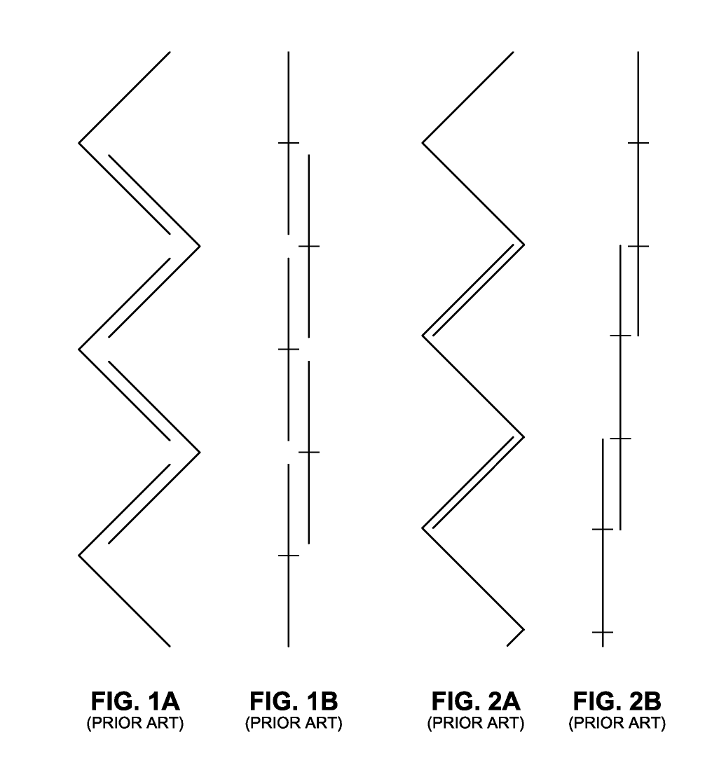

While the invention will be described in connection with certain preferred embodiments, there is no intent to limit it to those embodiments. On the contrary, the intent is to cover all alternatives, modifications and equivalents as included within the spirit and scope of the invention.

### DETAILED DESCRIPTION OF THE INVENTION

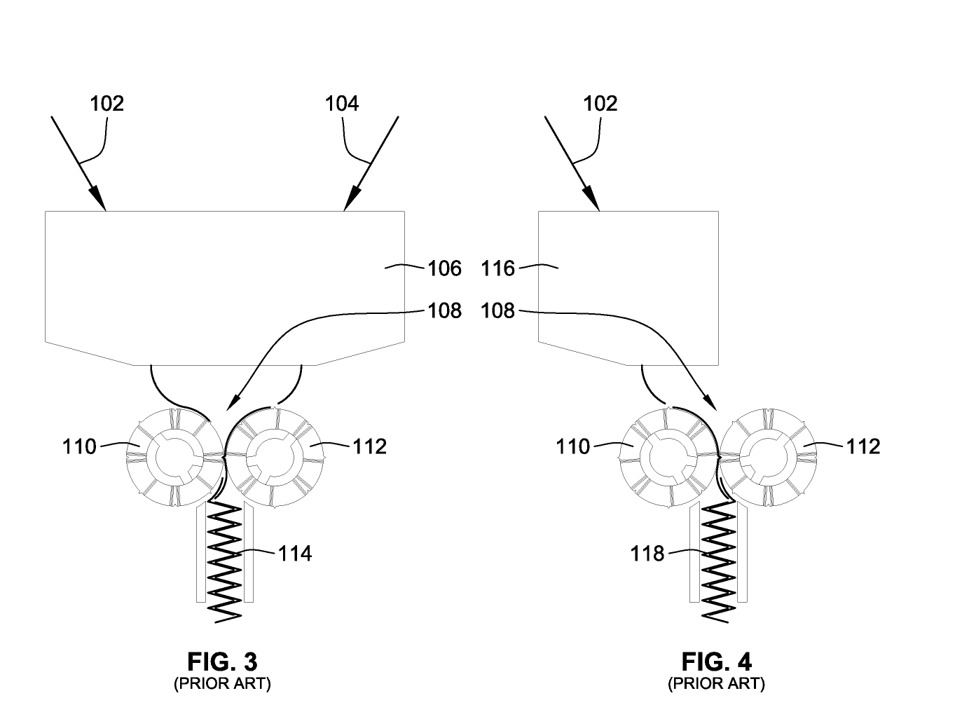

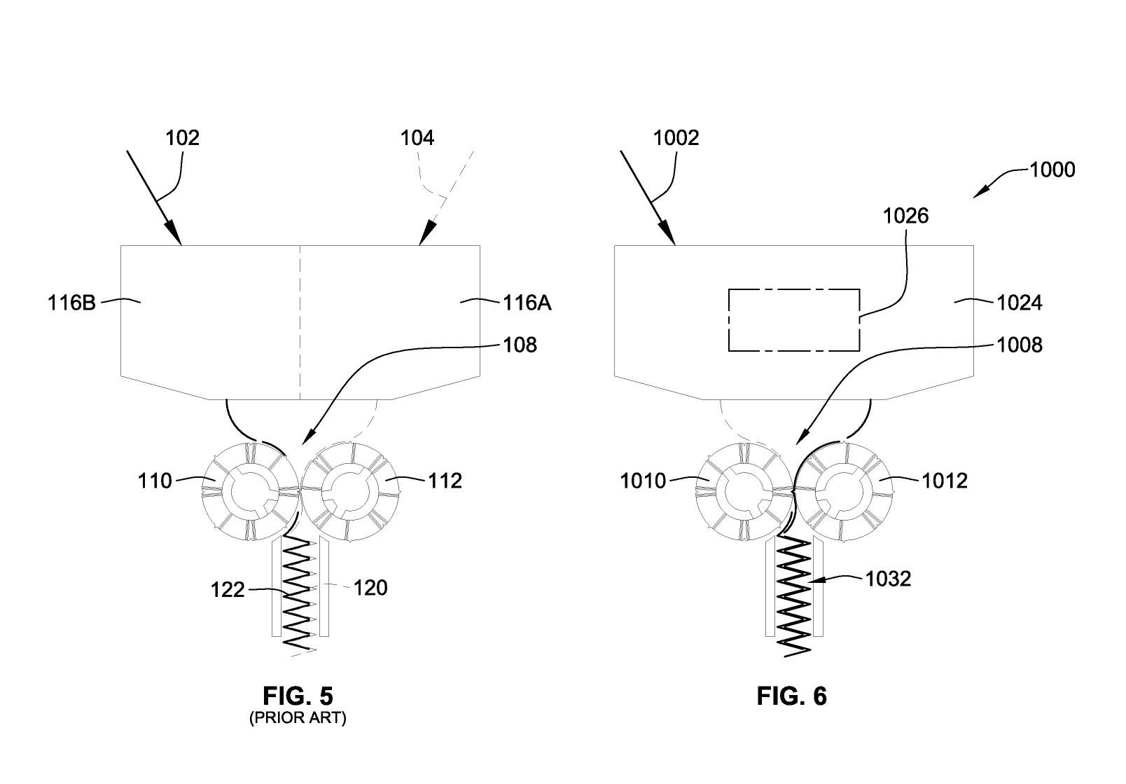

FIG. 6 is a schematic illustration of a first exemplary embodiment of a folding apparatus 1000 of the present invention, in which a single web of material 1002 is fed into a sheet cutting and directing arrangement 1024 having a sheet crossover arrangement 1026 which can be selectively activated in certain operational modes to direct successive sheets cut from the single web 1002 alternately down a first and a second path 1028, 1030 through the nip 1008 to produce a single-folded pattern 1032, similar to a pattern produced by the machine shown in FIG. 3, but without having two webs feeding into the machine. It is contemplated that the invention would be operable in a variety of operating modes to produce, in one machine, single-fold or multi-fold configurations similar to those which might be produced by two or more of the machines shown in FIGS. 3-5. It is further contemplated, that in some embodiments of the invention, a sheet cutting arrangement (not shown in FIG. 6) inside of the sheet feeding/cutting/overlapping arrangement 1024 would be capable of selectively producing sheets of various lengths, without the need for changing components in the manner typically required in present-day interfolding equipment. Such a variable cut-off arrangement might be accomplished in a manner similar to that shown in commonly assigned U.S. Pat. No. 6,296,601.

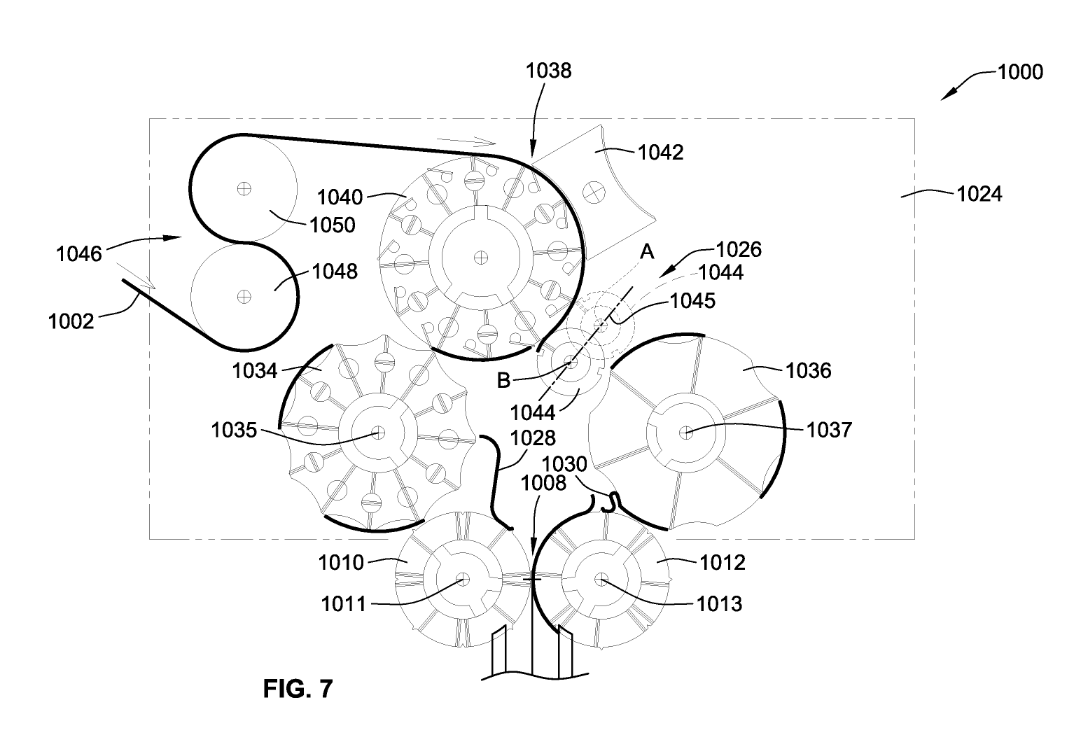

FIG. 7 shows a more detailed schematic illustration of the first exemplary embodiment of a folding apparatus 1000, according to the invention.

As shown in FIG. 7, the first and second folding rolls 1010, 1012 are mounted for rotation about respective parallel axes of rotation 1011, 1013.

As further illustrated in FIG. 7, the sheet cutting and directing arrangement 1024 of the first exemplary embodiment of the folding apparatus 1000 includes: a primary lap roll 1034; a secondary lap roll 1036; a variable cut-off arrangement 1038, having a knife roll 1040 and an anvil 1042; a sheet crossover arrangement 1026 in the form of a sheet crossover roll 1044; and a web feeding arrangement 1046 in the form of first and second pull rolls 1048, 1050. The primary and secondary lap rolls 1034, 1036 are mounted for rotation about respective rotational axes 1035, 1037. The crossover roll 1044 is mounted for rotation about a crossover roll axis 1045, which is moveable between at least first and second positions A, B of the crossover roll axis 1045. It will be understood that the respective axes 1045, 1035, 1037 of the crossover roll 1044, the primary lap roll 1034 and the secondary lap roll 137 all extend substantially parallel to one another and also parallel to the rotational axes 1011, 1013 of the first and second folding rolls 1010, 1012 respectively.

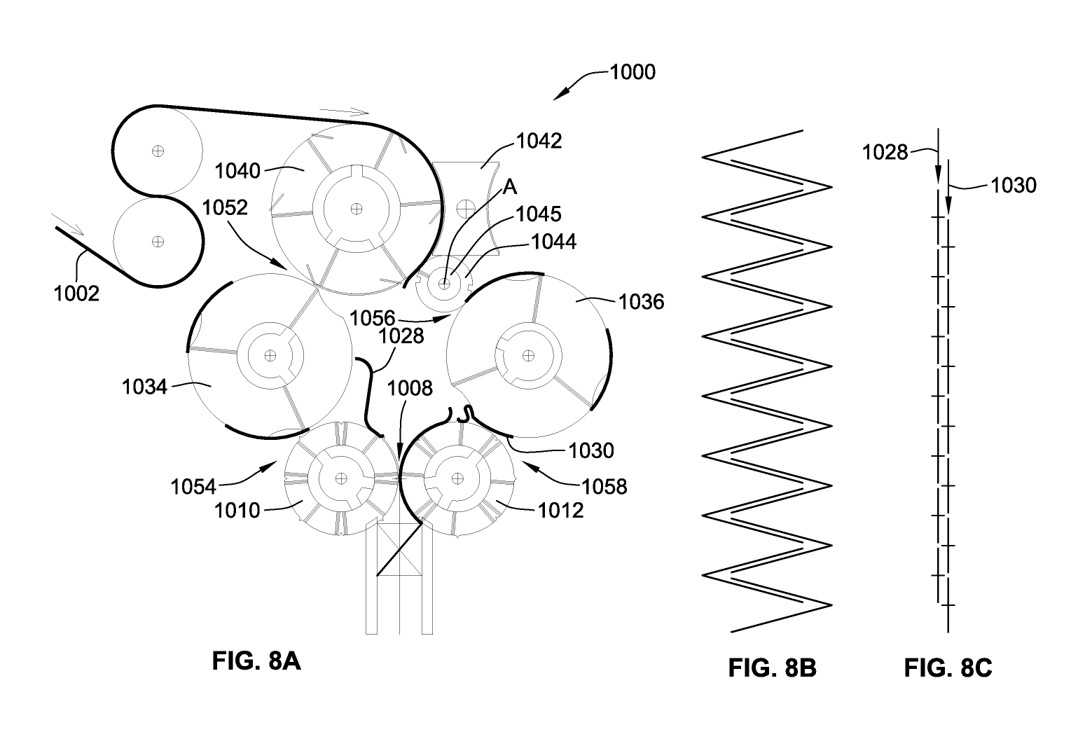

FIG. 8A illustrates the manner in which the first exemplary embodiment of the folding apparatus 1000 is utilized to form a single-fold interfolded pattern of V-shaped sheets, as illustrated in FIG. 8B, from a single web of material 1002, by cutting and directing successive sheets cut from the single web of material 1002 into two parallel streams of sheets extending generally along the first and second sheet paths 1028, 1030 in the manner illustrated in FIG. 8C through the nip 1008 between the first and second folding rolls 1010, 1012. This is accomplished by using the crossover roll 1044 to direct every other sheet along the second sheet path 1030, while allowing the alternate sheets to pass along the first sheet path 1028.

More specifically, the knife roll 1040, the primary and secondary lap rolls 1034, 1036 and the crossover roll 1044 include cooperatively controlled gripping and sheet handling devices, in the form of mechanical grippers, or vacuum ports, or some combination of these features or the like. These features are well-known in the art and are not specifically illustrated herein. It is further well-known in the art to control the application and removal of vacuum, the angular positions of actuation and release of mechanical grippers, and the application of blasts of air or positioning of other guiding devices or elements to cause a sheet passing through a folding apparatus to transfer in a desired manner between adjacent rolls.

When operating in the manner illustrated in FIGS. 8A-8C, the web is cut into successive sheets and the crossover roll 1044 is used to direct every other sheet away from the first sheet path 1028 and onto the second sheet path 1030 to form two parallel sheet streams passing through the nip 1008 between the folding rolls 1010, 1012.

As a first sheet passes by the crossover roll 1044, no vacuum is applied to ports in the periphery of the crossover roll 1044 so that the first sheet simply travels along with the periphery of the knife roll 1040 to a point of close proximity of the periphery of the knife roll 1040 with the periphery of the primary lap roll 1034 at a nip 1052 between the knife roll 1040 and the primary lap roll 1034. As the first sheet passes through the nip 1052 between the knife roll 1040 and the primary lap roll 1034, gripping and/or vacuum port elements in the knife roll 1040 and primary lap roll 1034 are controlled in such a manner that the first sheet transfers to the outer periphery of the primary lap roll and travels (in a counter-clockwise direction, as illustrated in FIG. 8A), around the periphery of the primary lap roll 1034. The first sheet continues around the periphery of the primary lap roll 1034 to a point of transfer proximate to a nip 1054 between the first folding roll 1010 and the primary lap roll 1034, where the first sheet is then transferred to gripping arrangements on the periphery of the first folding roll 1010. In this manner, the first sheet is directed by the sheet cutting and directing arrangement 1024 sequentially along the first sheet path 1028 as defined by portions of the peripheries of the knife roll 1040, the primary lap roll 1034, and the first folding roll 1010.

As the next sheet on the outer periphery of the knife roll 1040 approaches the crossover roll 1044, vacuum ports or other gripping elements in the knife roll 1040 and the crossover roll 1044 are cooperatively controlled in such a manner that the next sheet is transferred from the outer periphery of the knife roll 1040 to the outer periphery of the crossover roll 1044. The crossover roll 1044 transports the next sheet to a point of intersection at a nip 1056 between the crossover roll 1044 and the secondary lap roll 1036. Vacuum ports or other gripping arrangements in the crossover roll 1044 and the secondary lap roll 1036 are cooperatively controlled in such a manner that the next sheet is transferred from the outer periphery of the crossover roll 1044 to the outer periphery of the secondary lap roll 1036.

The secondary lap roll 1036 in turn transports the next sheet to a point proximate to a nip 1058 formed between the secondary lap roll 1036 and the second folding roll 1012, where at vacuum ports or other gripping arrangements in the secondary lap roll 1036 and the second folding roll 1012 are cooperatively controlled in such a manner that the next sheet is transferred from the outer periphery of the secondary lap roll 1036 to the outer periphery of the second folding roll 1012. In this manner the next sheet is transported along the second of the two parallel streams of sheets 1030 successively along the outer peripheries of the knife roll 1040, the crossover roll 1044, the secondary lap roll 1036 and the second folding roll 1012.

The processes described above for the first and next sheets then repeats continually in such a manner that every other sheet is directed to the first sheet stream 1028 and the alternate sheets are directed to the second sheet stream 1030.

As illustrated in FIGS. 8B and 8C, when configured and operated in the manner shown in FIG. 8A and described above, the knife roll 1040 and anvil 1042 cooperate to cut the single web of material 1002 into a succession of sheets having a length equal to two panels joined at a common fold line to form a V-shaped sheet. The physical size, shape and relative locations of the various components of the folding apparatus 1000 are judiciously coordinated in such a manner that the sheets traveling in the first and second parallel streams 1028, 1030 sheets are offset from one another by a distance substantially equal to one panel length. In this manner, an interfolded single-fold pattern of sheets such as illustrated in FIG. 8B is provided. Because the leading and trailing edges of the sheets on either side of a folded sheet are positioned essentially at the fold of the folded sheet, the pattern produced as illustrated in FIG. 8B and described hereinabove is known in the industry as an “on-fold” pattern. It will be further noted, that in the illustration shown in FIG. 8A, the axis 1045 of the crossover roll 1044 is disposed at location ‘A’ with respect to one or the other of the lap rolls 1034, 1036.

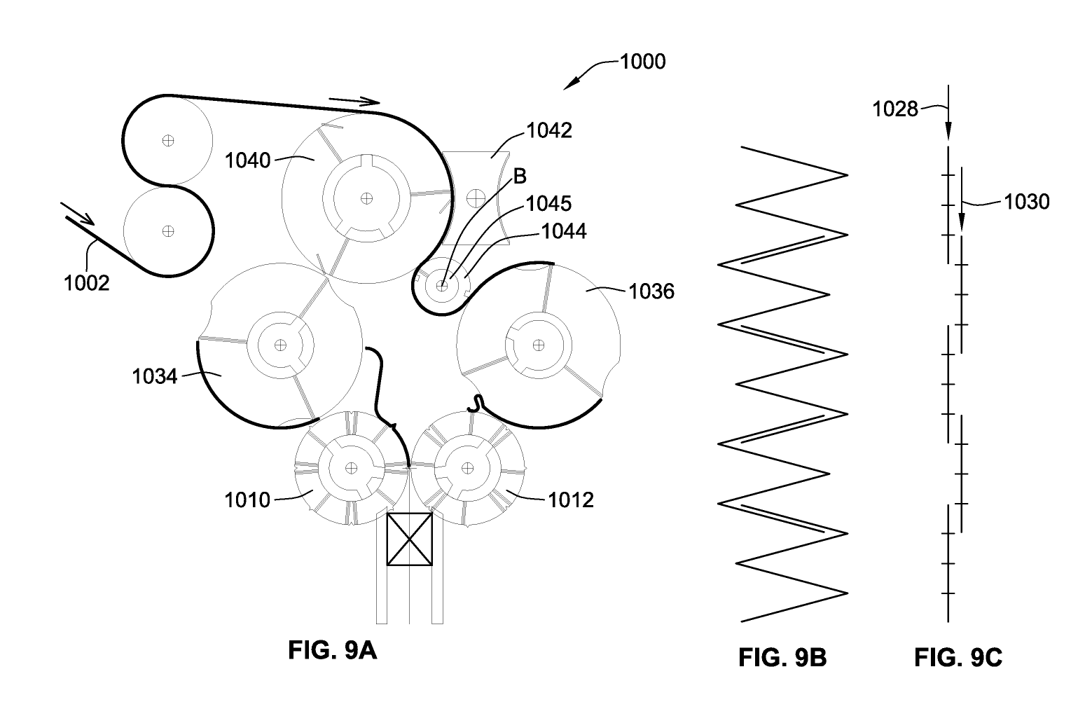

FIGS. 9A-9C illustrate the manner in which the first exemplary embodiment 100 of the folding apparatus can be utilized in much the same way as described above with regard to FIGS. 8A-8C to form a single-fold interfolded pattern of W-shaped sheets having four panels with the lead panel of each sheet overlapping the trailing panel of a preceding sheet. To form the W-shaped pattern shown in FIG. 9B, the rotational speeds of the lap rolls, and other parameters such as the positioning of the rotational axis 1045 of the crossover roll 1044 are adjusted, and the sheet cutting arrangement 1038 is operated to produce longer sheets. The timing of the travel of a first and a next sheet along the first and second parallel sheet paths 1028, 1030 is adjusted in such a manner that the leading and trailing edges of successive sheets in the first and second paths 1028, 1030 respectively overlap one another by approximately one-quarter of the sheet length, rather than overlapping one another by one-half of the sheet length as shown in the embodiment of FIG. 8C.

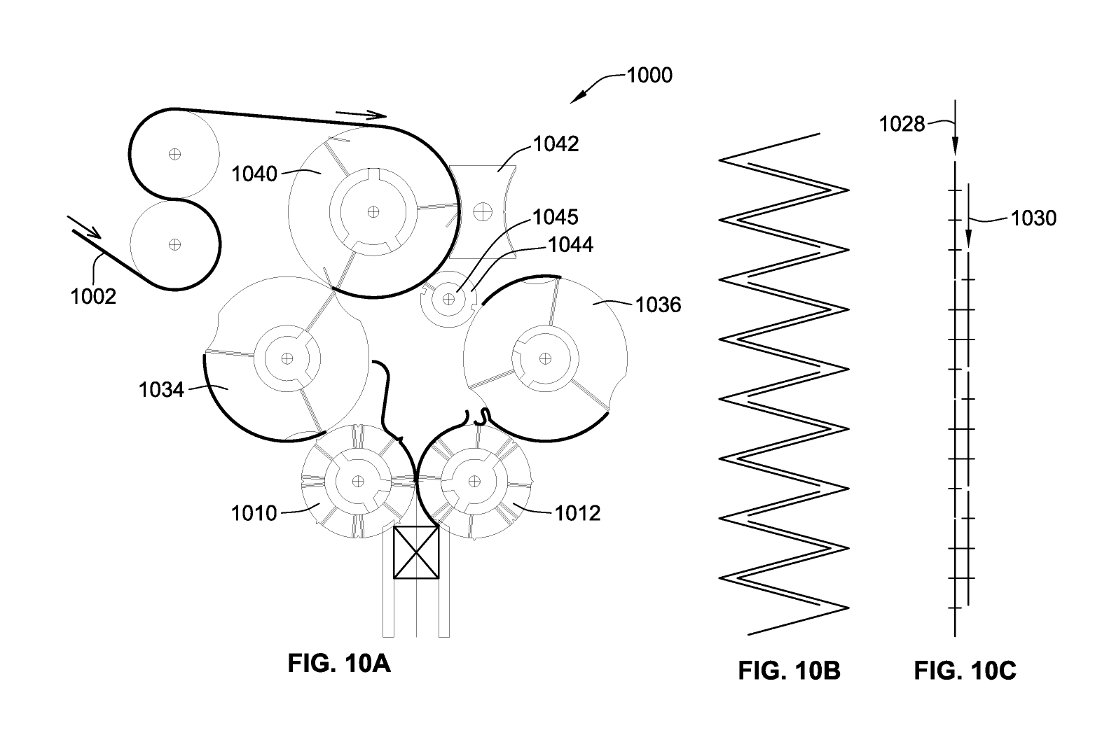

In FIGS. 10A-10C, the first exemplary embodiment of the folding apparatus 1000 is operated in a manner substantially the same as described above, with the apparatus 1000 adjusted to provide a single-fold, interfolded, on-fold pattern of W-shaped sheets having four panels, with successive sheets overlapping one another by three panels. To produce the configuration shown in FIG. 10B, the sheet cutting arrangement 1038 is operated in essentially the same manner as was utilized to produce the pattern shown in FIG. 9B to produce sheets having a length equal to four panels. The folding apparatus 1000 is utilized to vary the relative time of transport of the first and next sheets along the first and second sheet paths 1028, 1030 in such a manner that the sheets in the two parallel paths of FIG. 10C are overlapped in their parallel paths by three panel lengths, whereas the sheets in the respective first and second parallel paths 1028, 1030 of FIG. 9C are overlapped by only a single panel width.

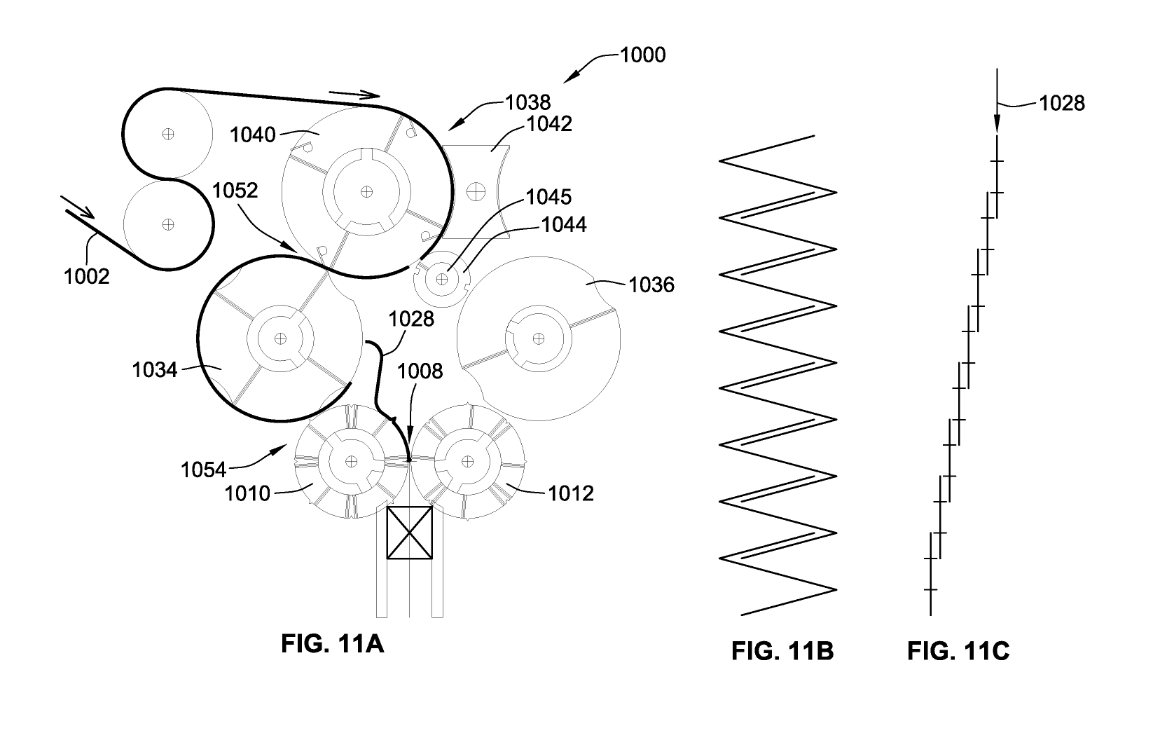

FIGS. 11A-11C illustrate one example of how the first exemplary embodiment of the folding apparatus 1000 may also be utilized in a first multi-fold mode of operation for producing a multi-fold pattern of interfolded sheets using the first lap roll 1034. To operate the apparatus 1000 in such a first multi-fold mode, in the manner illustrated in FIG. 11A, the crossover roll 1044 and the secondary lap roll 1036 are essentially disabled. In various embodiments of the invention it is contemplated that these rolls 1044, 1036 may be disabled simply by completely removing the vacuum supply from the crossover roll 1044, where a vacuum gripping arrangement is utilized. In other embodiments of the invention, it is contemplated that the crossover roll 1044 may be physically moved out of proximity to the knife roll 1040. With the crossover roll 1044 disabled, all of the sheets cut from the single web 1004 of material by the cutting arrangement 1038 travel sequentially from the outer periphery of the knife roll 1040 to the outer periphery of the primary lap roll 1034 and then to the outer periphery of the first folding roll 1010 along only the first sheet path 1028. Rotational speed of the primary lap roll 1034 relative to the folding roll 1010 is adjusted so that the surface speed of the primary lap roll is sufficiently higher than the surface speed of the folding rolls 1010, 1012 to cause a portion of the next sheet to slide underneath a portion of the first sheet to form the shingle-like pattern illustrated in FIG. 11C along the first sheet path 1028.

Specifically, in the first multi-fold operating mode and embodiments shown in FIGS. 11A-11C, the sheet cutting arrangement 1038 is operated to produce sheets having a length equal to three panels of equal length joined along two common fold lines to form Z-shaped sheets. The speed differential between the surface of the primary lap roll 1034 and the folding rolls 1010, 1012 is adjusted in such a manner that the successive sheets overlap one another by one panel length, in order to produce the multi-fold pattern shown in FIG. 11B of Z-shaped sheets interfolded with one another and overlapped by a single panel width.

Those having skill in the art will recognize that the exemplary embodiment of the folding apparatus 1000 may be utilized in the first multi-fold mode to produce other multi-fold interfolded patterns by varying the length of the sheets and the speed difference between the primary lap roll 1034 and the folding rolls 1010 and 1012.

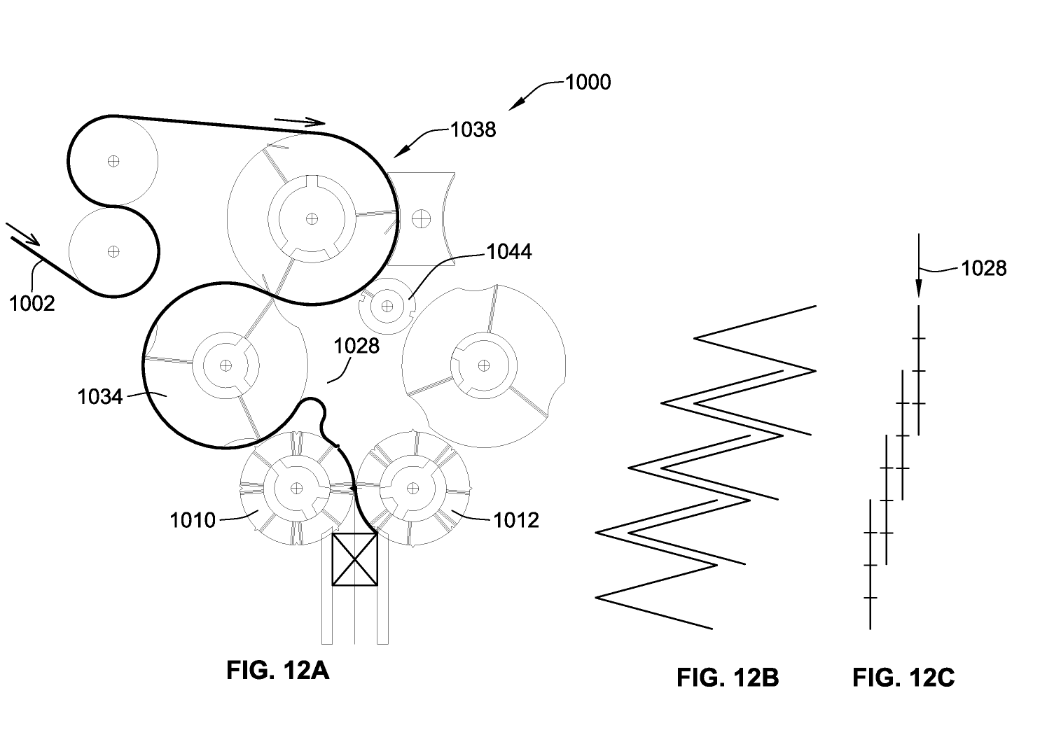

For example, as illustrated in FIGS. 12A-12C, the first exemplary embodiment of the folding apparatus 1000 may be operated in essentially the same manner as described above with regard to the embodiment shown in FIGS. 11A-11C to produce a multi-fold pattern of interfolded sheets having a W-shape with two panels of successive sheets being overlapped with one another. It will be understood, by those having skill in the art, that other multi-fold patterns having different sheet lengths, numbers of panels, and different overlapping combinations can also be readily produced in accordance with the invention by disabling the crossover roll 1044 and making appropriate adjustments to the sheet lengths provided by the cutting arrangement 1038 and the speed differential between the primary lap roll 1034 and the folding rolls 1010, 1012.

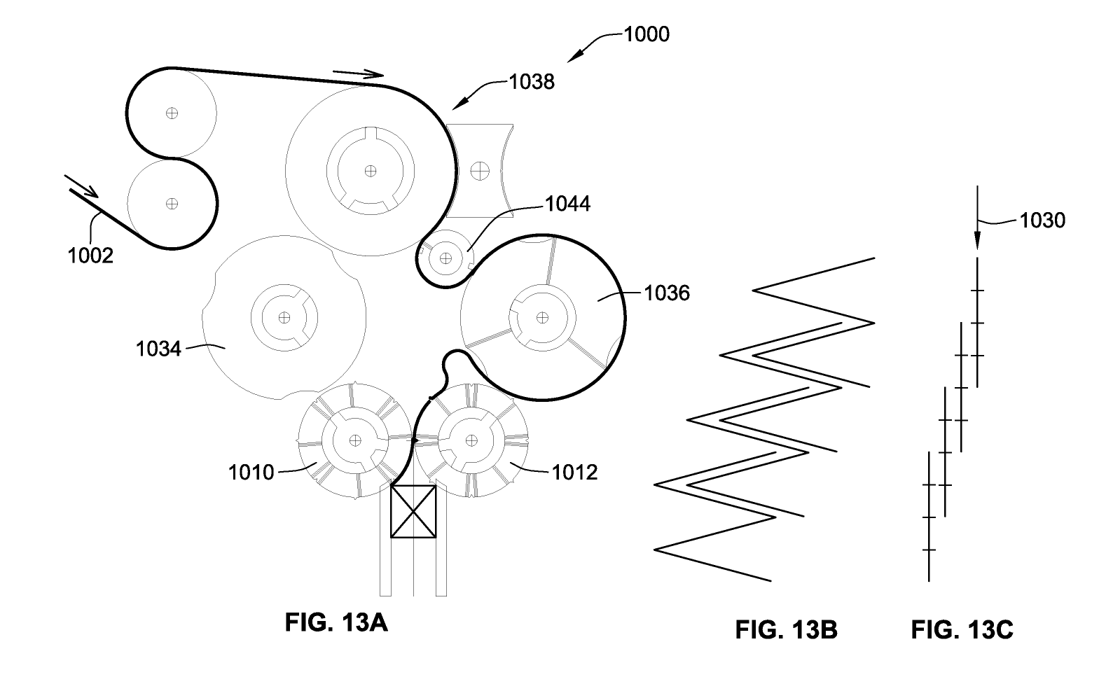

FIGS. 13A-13C illustrate one example of how the first exemplary embodiment of the folding apparatus 1000 may also be utilized in a second multi-fold mode of operation for producing a multi-fold pattern of interfolded sheets using the secondary lap roll 1036. To operate the apparatus 1000 in such a second multi-fold mode, in the manner illustrated in FIG. 13A, the crossover roll 1044 is not disabled and the secondary lap roll 1036 is utilized for forming the multi-fold pattern from a continuous stream of sheets, rather than the primary lap roll 1034 as was the case for the first multi-fold mode described above in relation to FIGS. 11A-11c and FIGS. 12A-12C. In the second multi-fold mode, the first lap roll 1034 is inactive and may be disabled simply by completely removing the vacuum supply where a vacuum gripping arrangement is utilized in the primary lap roll 1034. In other embodiments of the invention, it is contemplated that the primary lap roll 1034 will simply be allowed to continue operating in its normal manner, because the crossover roll 1044 directs all sheets to the secondary lap roll 1036 upstream from the primary lap roll 1034.

In the second multi-fold mode, the crossover roll 1044 directs all of the sheets cut from the single web 1004 of material by the cutting arrangement 1038 sequentially from the outer periphery of the knife roll 1040 to the outer periphery of the secondary lap roll 1036 and then to the outer periphery of the second folding roll 1012 along only the second sheet path 1030. Rotational speed of the secondary lap roll 1036 relative to the folding rolls 1010, 1012 is adjusted so that the surface speed of the secondary lap roll is sufficiently higher than the surface speed of the folding rolls 1010, 1012 to cause a portion of the next sheet to slide underneath a portion of the first sheet to form the shingle-like pattern illustrated in FIG. 13C along the second sheet path 1030.

Those having skill in the art will recognize that the exemplary embodiment of the folding apparatus 1000 may be utilized in the second multi-fold mode to produce a variety of multi-fold interfolded patterns by varying the length of the sheets and the speed difference between the secondary lap roll 1034 and the folding rolls 1010 and 1012.

For example, as illustrated in FIGS. 13A-13C, the first exemplary embodiment of the folding apparatus 1000 may be operated in the second multi-fold mode to produce a multi-fold pattern of interfolded sheets having a W-shape with two panels of successive sheets being overlapped with one another.

It will further be understood that forms of the first exemplary embodiment are contemplated in which the first exemplary embodiment of the folding apparatus 1000 may be configured to alternatively produce either a first multi-fold pattern when operated in the first folding mode, using the primary lap roll 1034 without the crossover roll 1044, as described above in relation to FIGS. 11A-11C, or a second multi-fold pattern when operated in the second folding mode, using the secondary lap roll 1036 with the crossover roll 1044 in the manner described above in relation to FIGS. 13A-13C. Specifically, according to one contemplated embodiment of the invention, the exemplary embodiment of FIG. 1000 may be used for forming the Z-shaped, three-panel multi-fold pattern of FIGS. 11B and 11C when operating in the first operating mode, and alternatively be used for forming the W-shaped, four-panel multi-fold pattern of FIGS. 13B and 13C when operating in the second multi-fold mode. This capability to produce two different multi-fold patterns with the same machine without physically changing out any of the rolls of the machine provides significant advantages over prior approaches in which two separate machines, or changing out of some of the rolls, was necessary to produce to different multi-fold patterns.

Those having skill in the art will recognize that the exemplary embodiment of the folding apparatus 1000 may be utilized in various embodiments of the invention alternatively in either a first or a second multi-fold mode to produce a variety of multi-fold interfolded patterns by varying the length of the sheets and the speed difference between the primary lap roll 1034 or the secondary lap roll 1036 and the folding rolls 1010 and 1012 as necessary to produce the desired first and second multi-fold patterns.

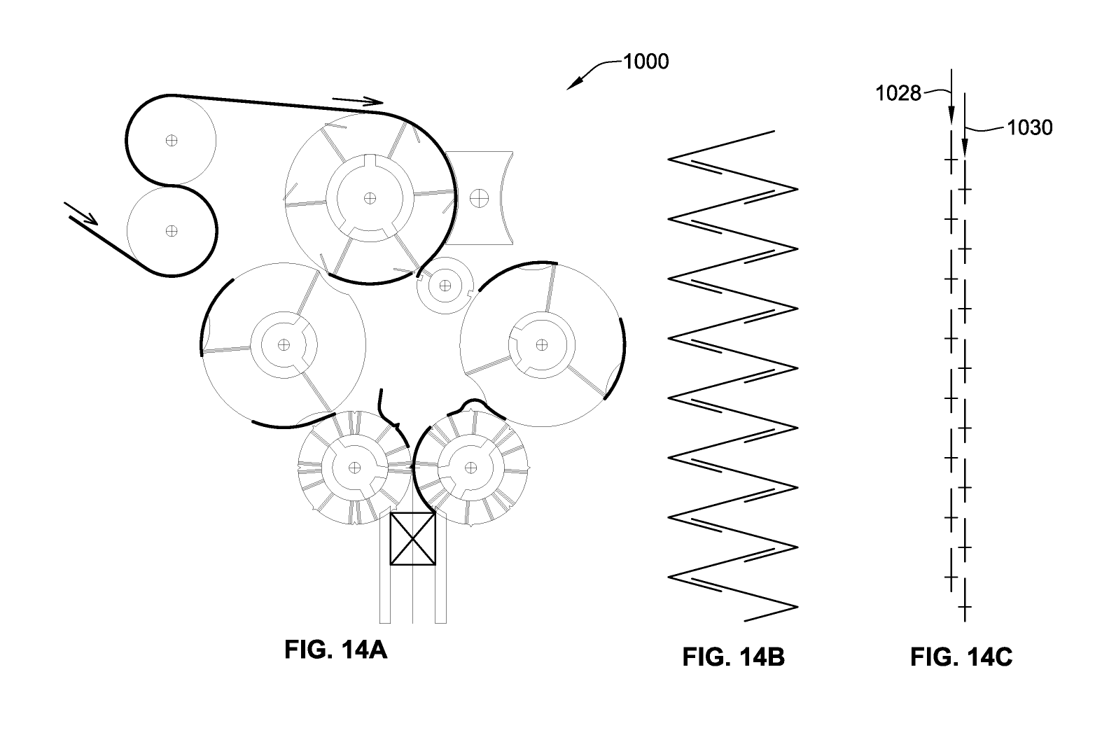

It will also be understood, that although all of the single-fold and multi-fold patterns described hereinabove are “on-fold” patterns in which the panels of the sheets are all of the same length, the invention may be practiced with efficacy to produce “off-fold” patterns in either a single-fold or a multi-fold pattern as illustrated in FIGS. 14A and 14B. In the single-fold, off-fold pattern illustrated in FIG. 14B, for example, sheets of approximately 1⅓ panel lengths are cut and directed along the parallel sheet paths 1028, 1030 in such a manner that successive sheets overlap one another by approximately ⅓ panel length. By virtue of the geometry of the folding rolls 1010, 1012 being configured to provide successive folds at one full panel length spacing from one another, the off-fold single-fold pattern of FIG. 14B is produced. Although not expressly illustrated in the drawings, it will be recognized that off-fold multi-fold patterns may also be produced in accordance with an apparatus and/or method according to the invention.

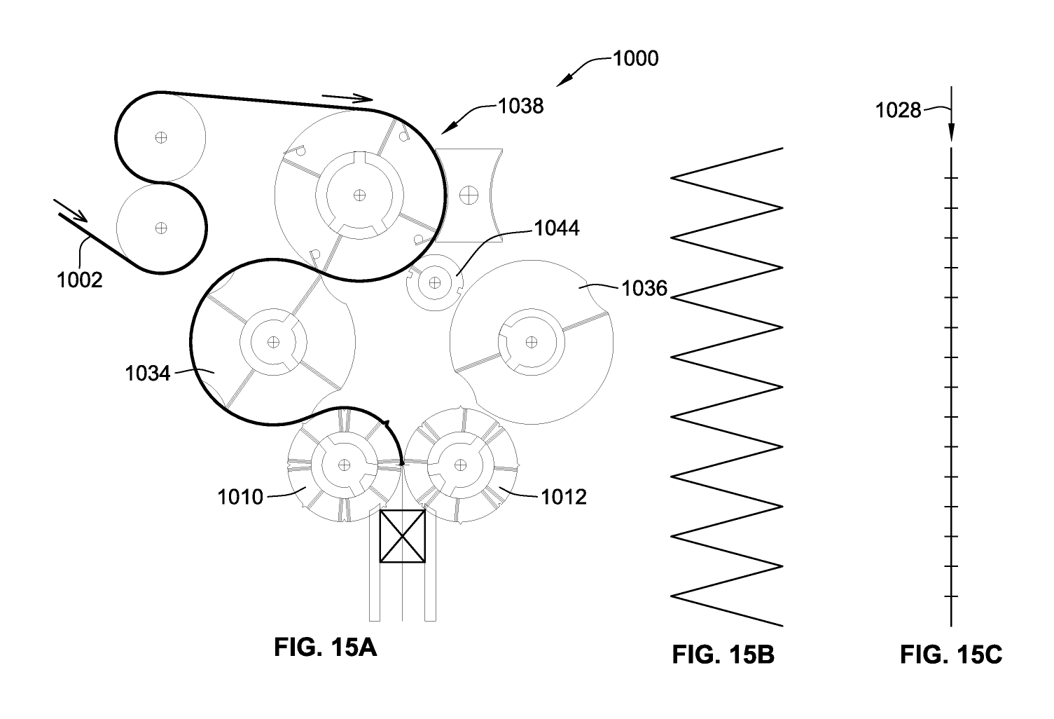

FIGS. 15A and 15B illustrate another mode of operation of the first exemplary embodiment of the folding apparatus 1000 to produce a zig-zag pattern such as the one illustrated in FIG. 15B from the single web of material 1004. In the zig-zag mode of operation, the crossover roll 1044 and secondary lap roll 1036 are disabled in the same manner as described above for production of various multi-fold patterns. In the zig-zag mode, however, the peripheral speed of the primary lap roll 1035 is adjusted to match the peripheral speed of the folding rolls 1010, 1012, and the cutting arrangement 1038 is operated to produce a sheet from the single web 1004 having a length equal to a number of panels. The cutting arrangement 1038 is actuated only at the beginning and end of the zig-zag folded sheet to perform a “count” operation to produce a “pack” of the zig-zag folded sheet having a desired number of panels. Such zig-zag folded patterns are sometimes utilized in dispensers having integral cutters to cut the zig-zag folded pack to a desired length as the sheets are dispensed. In the embodiment illustrated in FIGS. 14B and 14C, there is no overlapping between successive zig-zag folded sheets, but it will be understood that an apparatus and/or method according to the invention may be utilized to provide some degree of overlap of successive zig-zag folded sheets.

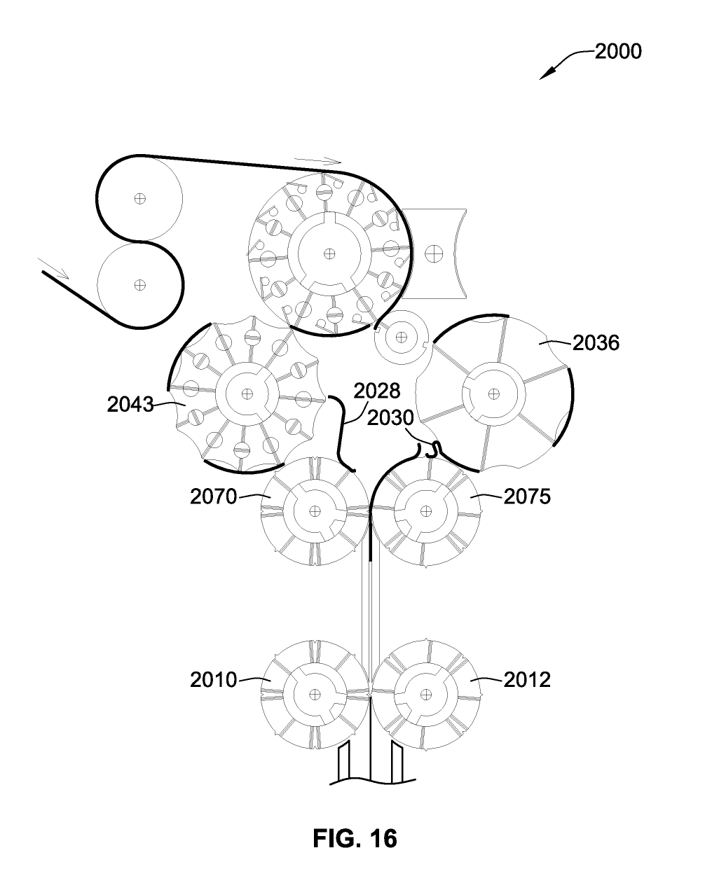

In all of the exemplary embodiments described hereinabove thus far, the sheets are transferred directly from the peripheries of one or both of the lap rolls 1034, 1036 directly onto the peripheries of one or the other of the folding rolls 1010, 1012. Such direct transfer from the lap rolls 1034, 1036 to the folding rolls 1010, 1012 is not required, however, in practicing the invention. In some embodiments of the invention, such as the one shown in FIG. 16 for example, a conveying arrangement 2065 may be disposed between the lap rolls 2034, 2036 and the folding rolls 2010, 2012 for transporting one or more streams of overlapped sheets to the nip 2008 between the folding rolls 2010, 2012. Where such an arrangement is utilized in an embodiment of the invention operating in a single-fold pattern to produce a single-fold mode to produce a single-fold pattern, the first and second sheet streams are transported in parallel to one another along the first and second sheet paths 2028, 2030. Where such an arrangement is utilized in a multi-fold mode for producing a multi-fold product, the sheets are overlapped in a shingle-like stream by running one of the lap rolls 2034 or 2036 at higher speed than an adjacent roll 2070, 2075 turning at the same speed as the folding rolls 2010, 2012, to form the single sheet stream fed through the nip 2008 by the conveying arrangement 2065.

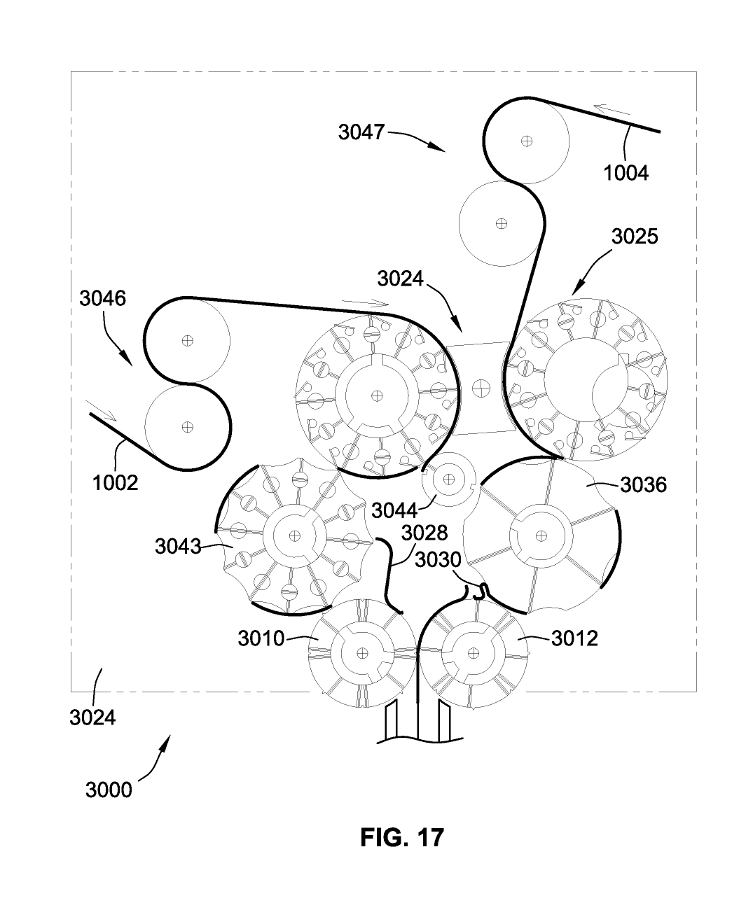

FIG. 17 illustrates yet another exemplary embodiment of a folding apparatus 3000, according to the invention, which is capable of producing any of the single-fold, multi-fold or zig-zag fold patterns described hereinabove from a single web 1002 of material, and is also capable of operation in a dual-mode, alternate single-fold mode for producing a single-fold pattern from sheets cut from two webs 1002, 1004 of material. Specifically, the embodiment shown in FIG. 17 includes an additional sheet cutting arrangement 3025 and an additional sheet feeding arrangement 3047 for receiving a second web of material 1004 and feeding sheets cut therefrom along the second path 3030 to the nip 3008 between the folding rolls 3010, 3012. In this configuration, these extra components form part of the sheet cutting and directing arrangement 3024, in accordance with the invention. When operated with two webs of sheet material 1002, 1004, to produce a single-fold pattern similar to those shown in FIGS. 8B, 9B, or 10B, or any other single-fold pattern, the crossover roll 3044 of the sheet-cutting and directing arrangement 3024 is disabled so that the sheets cut from the first web of material 1002 are directed along the first path 3028 and the sheets cut from the second web of material 1004 are directed along the second path 3030 in two parallel sheet streams through the nip 3008.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventor for carrying out the invention. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A folding apparatus for forming a pattern of single-folded sheets from a single web of material, the folding apparatus comprising:
a pair of counter-rotating first and second folding rolls forming a nip therebetween for passage through the nip of at least one stream of sheets; and
a sheet cutting and directing arrangement operable in a single-fold mode for cutting and directing successive sheets cut from the single web of material alternatively along first and second paths extending through the nip in two parallel streams of sheets to produce the single-folded pattern of interfolded sheets.

2. The folding apparatus of claim 1, wherein, the sheet cutting and directing arrangement is also configured for operation alternatively in a multi-fold mode in which the sheet cutting and directing arrangement directs all of the successive sheets through the nip in a single stream of sheets with the successive sheets overlapped in a shingle-like orientation.

3. The folding apparatus of claim 2, wherein, the sheet cutting and directing arrangement is configured for operation in a first multi-fold mode of operation wherein all of the successive sheets are directed into a single stream of successive sheets entering the nip along only the first path and passing through the nip with successive sheets overlapped in a shingle-like manner to produce a first multi-folded pattern of interfolded sheets.

4. The folding apparatus of claim 3, wherein, the sheet cutting and directing arrangement is configured for operation of the sheet cutting and directing arrangement alternatively in a second multi-fold mode of operation wherein all of the successive sheets are directed into a single stream of successive sheets entering the nip along only the second path and passing through the nip with successive sheets overlapped in a shingle-like manner to produce a second multi-folded pattern of interfolded sheets.

5. The folding apparatus of claim 2, wherein, the sheet cutting and directing arrangement is configured such that for operation of the sheet cutting and directing arrangement alternatively in the multi-fold mode of operation all of the successive sheets are directed into a single stream of successive sheets entering the nip along only the second path and passing through the nip with successive sheets overlapped in a shingle-like manner to produce the multi-folded pattern of interfolded sheets.

6. The folding apparatus of claim 1, wherein, the sheet cutting and directing arrangement is further configured for operation of the sheet cutting and directing arrangement alternatively in a zig-zag-fold mode in which the sheet cutting and directing arrangement directs a length of the single web of material through the nip without cutting the length of web into successive sheets to form a zig-zag-fold pattern having the length of the single web of material folded to form a plurality of panels joined to one another along common fold lines disposed between adjacent panels.

7. The folding apparatus of claim 1, wherein, the cutting and directing arrangement is configured for receiving a first and a second web of material and operation alternatively in a dual-web alternate single-fold mode for cutting and directing successive sheets cut from the first and second webs of material along first and second paths extending through the nip in the two parallel streams of sheets to produce the single-folded pattern of interfolded sheets.

8. The folding apparatus of claim 1, wherein, the sheet cutting and directing arrangement directs the successive sheets through the nip in an overlapped manner, and further comprises an overlapped sheet conveying arrangement for transporting the overlapped sheets to the nip.

9. The folding apparatus of claim 1, wherein, the sheet cutting and directing arrangement includes a variable cut-off arrangement for selectively producing one of two or more different lengths of successive sheets.

10. The folding apparatus of claim 1, wherein, the sheet cutting and directing arrangement includes a sheet crossover arrangement for directing every other one of the successive sheets cut from the single web of material alternately down the first and second paths through the nip.

11. The folding apparatus of claim 10, wherein, the sheet cutting and directing arrangement includes a variable cut-off arrangement for selectively producing one of two or more different predetermined lengths of successive sheets.

12. The folding apparatus of claim 10, wherein:
the sheet cutting and directing arrangement is operable in a zig-zag folding mode in which the sheet crossover arrangement is operated to direct successive sheets along only one of the first and second paths; and
the sheet cutting and directing arrangement directs a length of the single web of material through the nip without cutting the length of web into successive sheets to form a zig-zag-fold pattern having the length of the single web of material folded to form a plurality of panels joined to one another along common fold lines disposed between adjacent panels.

13. The folding apparatus of claim 10, wherein:
the cutting and directing arrangement includes a knife roll for cutting the web into the successive sheets, a primary lap roll and a secondary lap roll each operatively disposed for directing the successive sheets to the folding rolls; and
the sheet crossover arrangement includes a sheet crossover roll for receiving alternating ones of the successive sheets from the knife roll and directing the alternating ones of the successive sheets to the secondary lap roll, in such a manner that a first stream of the two parallel sheet streams comprising alternating ones of the successive sheets travels along the first path through the nip by being transferred sequentially from the knife roll, to the primary lap roll, to the first folding roll of the pair of folding rolls, while a second stream of the parallel sheet streams comprising every other alternating one of the successive sheets travels along the second path through the nip by being transferred sequentially from the knife roll, to the crossover roll, to the secondary lap roll, to the second folding roll of the pair of folding rolls.

14. The folding apparatus of claim 13, wherein, the sheets are respectively transferred directly from the primary lap roll to the first folding roll and directly from the secondary lap roll to the second folding roll.

15. The folding apparatus of claim 13, wherein:
the sheet cutting and directing arrangement further comprises a conveying arrangement disposed downstream from the primary and secondary lap rolls; and
the sheets are transferred indirectly from the primary and secondary lap rolls to the folding rolls by the conveying arrangement.

16. The folding apparatus of claim 13, wherein, the sheet cutting and directing arrangement includes a variable cut-off arrangement for selectively producing one of two or more different predetermined lengths of successive sheets.

17. The folding apparatus of claim 16, wherein, the primary and secondary lap rolls and the crossover roll all are rotatable about respective axes thereof, and the crossover roll axis is movable with respect to at least one of axes the primary and secondary lap rolls between at least:
a first position thereof corresponding to the first predetermined sheet length; and
a second position thereof corresponding to the second sheet length.

18. The folding apparatus of claim 17, wherein, the crossover roll is disposed at the first position thereof for a first sheet length, and at the second position thereof for the second sheet length.

19. The folding apparatus of claim 16, wherein, the variable cut-off arrangement includes the knife roll.

20. The folding apparatus of claim 13, wherein, the crossover roll is selectively disengagable for operation of the apparatus in a multi-fold mode of operation wherein all of the successive sheets are transferred from the knife roll to only one of the primary and secondary lap rolls to form a single stream of successive sheets entering the nip along only one of the first and second paths and passing through the nip with successive sheets overlapped in a shingle-like manner to produce a multi-folded pattern of interfolded sheets.

21. The folding apparatus of claim 20, wherein, the sheet cutting and directing arrangement further comprises a variable cut-off arrangement, for selectively producing one of two or more different lengths of successive sheets.

22. The folding apparatus of claim 21, wherein, the variable cut-off arrangement includes the knife roll.

23. The folding apparatus of claim 20, wherein, the crossover roll is disengaged for operation in a first multi-fold mode of operation wherein all of the successive sheets are transferred from the knife roll to the primary lap roll to form a single stream of successive sheets entering the nip along only the first path and passing through the nip with successive sheets overlapped in a shingle-like manner to produce a first multi-folded pattern of interfolded sheets.

24. The folding apparatus of claim 20, wherein, the crossover roll is not disengaged for operation in a second multi-fold mode of operation wherein all of the successive sheets are transferred by the crossover roll from the knife roll to the secondary lap roll to form a single stream of successive sheets entering the nip along only the second path and passing through the nip with successive sheets overlapped in a shingle-like manner to produce a second multi-folded pattern of interfolded sheets.

25. A method for forming a pattern of single-folded sheets from a single web of material using a pair of counter-rotating first and second folding rolls forming a nip therebetween for passage through the nip of at least one stream of sheets, the method comprising:
feeding the single web of material to a sheet cutting and directing arrangement configured for cutting and directing successive sheets cut from the single web of material alternatively along first and second paths extending through the nip in two parallel streams of sheets to produce the single-folded pattern of interfolded sheets;
cutting successive sheets from the single web of material with the sheet cutting and directing arrangement; and
directing the successive sheets cut from the single web of material alternatively along first and second paths extending through the nip in two parallel streams of sheets in a single-fold mode of operation to produce the single-folded pattern.

26. The method of claim 25, wherein, the sheet cutting and directing arrangement is also configured for operation alternatively in a multi-fold mode in which the sheet cutting and directing arrangement directs all of the successive sheets through the nip in a single stream of sheets with the successive sheets overlapped in a shingle-like orientation, and the method further comprises:
operating the sheet cutting and directing arrangement in the multi-fold mode of operation to produce a multi-folded pattern having the successive sheets overlapped in a shingle-like orientation.

27. The method of claim 26, wherein, the sheet cutting and directing arrangement is configured for operation in a first multi-fold mode of operation wherein all of the successive sheets are directed into a single stream of successive sheets entering the nip along only the first path and passing through the nip with successive sheets overlapped in a shingle-like manner to produce a first multi-folded pattern of interfolded sheets, and the method further comprises:
operating the sheet cutting and directing arrangement in the first multi-fold mode of operation to produce a first multi-folded pattern having the successive sheets overlapped in a shingle-like orientation.

28. The method of claim 26, wherein, the sheet cutting and directing arrangement is configured for operation of the sheet cutting and directing arrangement alternatively in a second multi-fold mode of operation wherein all of the successive sheets are directed into a single stream of successive sheets entering the nip along only the second path and passing through the nip with successive sheets overlapped in a shingle-like manner to produce a second multi-folded pattern of interfolded sheets, and the method further comprises:
operating the sheet cutting and directing arrangement in the second multi-fold mode of operation to produce a second multi-folded pattern having the successive sheets overlapped in a shingle-like orientation.

29. The method of claim 25, wherein, the sheet cutting and directing arrangement is further configured for operation of the sheet cutting and directing arrangement alternatively in a zig-zag-fold mode in which the sheet cutting and directing arrangement directs a length of the single web of material through the nip without cutting the length of web into successive sheets to form a zig-zag-fold pattern having the length of the single web of material folded to form a plurality of panels joined to one another along common fold lines disposed between adjacent panels, and the method further comprises:
operating the sheet cutting and directing arrangement in the zig-zag fold mode of operation to produce a zig-zag folded pattern having the length of the single web material folded to form a plurality of panels joined to one another along common fold lines disposed between adjacent panels.

30. The method of claim 25, further comprising, alternatively operating the sheet cutting and directing arrangement in an dual-web alternate single-fold mode in which in which the sheet cutting and directing arrangement cuts and directs successive sheets from two webs of material through the nip in two parallel streams of sheets to form the single-folded pattern.

31. The method of claim 30, wherein:
the cutting and directing arrangement includes first and second knife rolls for cutting the first and second webs respectively into first and second streams of successive sheets, a primary lap roll and a secondary lap roll each respectively operatively disposed for directing the first and second streams of successive sheets to the folding rolls;
the sheet crossover arrangement includes a sheet crossover roll for receiving alternating ones of the successive sheets from at least one of the knife rolls and directing the alternating ones of the successive sheets received from the one of the knife rolls to one of the primary and secondary lap rolls, in such a manner that a first stream of the parallel sheet streams comprising alternating ones of the successive sheets travels along the first path through the nip by being transferred sequentially from one of the knife rolls, to the primary lap roll, to the first folding roll of the pair of folding rolls, while a second stream of the parallel sheet streams comprising every other alternating one of the successive sheets travels along the second path through the nip by being transferred sequentially from the one of the knife rolls, to the crossover roll, to the secondary lap roll, to the second folding roll of the pair of folding rolls; and
the method further comprises, operating the sheet crossover arrangement in the dual-web alternate single-fold mode with the crossover roll disengaged and configured in such a manner that the first stream of the parallel sheet streams travels along the first path through the nip by being transferred sequentially from the first knife roll, to the primary lap roll, to the first folding roll of the pair of folding rolls, while the second stream of the parallel sheet streams travels along the second path through the nip by being transferred sequentially from the second knife roll, to the secondary lap roll, to the second folding roll of the pair of folding rolls.

32. The method of claim 25, further comprising:
directing the successive sheets through the nip in an overlapped manner; and
conveying the overlapped sheets to the nip with an overlapped sheet conveying arrangement.

33. The method of claim 25, further comprising:
feeding the single web of material to a sheet cutting and directing arrangement having a variable cut-off arrangement for selectively producing one of two or more different lengths of successive sheets; and
cutting the web to one of the two or more sheet lengths.

34. The method of claim 25, wherein, the sheet cutting and directing arrangement includes a sheet crossover arrangement for directing every other one of the successive sheets cut from the single web of material alternately down the first and second paths through the nip, in the single-fold mode of operation, and the method further comprises, using the sheet crossover arrangement in the single-fold mode of operation for directing every other one of the successive sheets cut from the single web of material alternately down the first and second paths through the nip.

35. The method of claim 34, wherein, the sheet cutting and directing arrangement includes a variable cut-off arrangement for selectively producing one of two or more different predetermined lengths of successive sheets, and the method further comprises operating the variable cut-off arrangement to cut the single web of material into successive sheets having one of the predetermined lengths of the successive sheets.

36. The method of claim 25, wherein:
the cutting and directing arrangement includes a knife roll for cutting the web into the successive sheets, a primary lap roll and a secondary lap roll each operatively disposed for directing the successive sheets to the folding rolls;
the sheet crossover arrangement includes a sheet crossover roll for receiving alternating ones of the successive sheets from the knife roll and directing the alternating ones of the successive sheets to the secondary lap roll, in such a manner that a first stream of the parallel sheet streams comprising alternating ones of the successive sheets travels along the first path through the nip by being transferred sequentially from the knife roll, to the primary lap roll, to the first folding roll of the pair of folding rolls, while a second stream of the parallel sheet streams comprising every other alternating one of the successive sheets travels along the second path through the nip by being transferred sequentially from the knife roll, to the crossover roll, to the secondary lap roll, to the second folding roll of the pair of folding rolls; and
the method further comprises, operating the sheet crossover arrangement for receiving on the crossover roll alternating ones of the successive sheets from the knife roll and directing the alternating ones of the successive sheets to the secondary lap roll, in such a manner that a first stream of the parallel sheet streams comprising alternating ones of the successive sheets travels along the first path through the nip by being transferred sequentially from the knife roll, to the primary lap roll, to the first folding roll of the pair of folding rolls, while a second stream of the parallel sheet streams comprising every other alternating one of the successive sheets travels along the second path through the nip by being transferred sequentially from the knife roll, to the crossover roll, to the secondary lap roll, to the second folding roll of the pair of folding rolls.

37. The method of claim 36, further comprising, transferring the sheets directly from the primary lap roll to the first folding roll and directly from the secondary lap roll to the second folding roll.

38. The method of claim 36, wherein:
the sheet cutting and directing arrangement further comprises a conveying arrangement disposed downstream from the primary and secondary lap rolls; and
the method further comprises transferring the sheets indirectly from the primary and secondary lap rolls to the folding rolls with the conveying arrangement.

39. The method of claim 36, wherein:
the sheet cutting and directing arrangement includes a variable cut-off arrangement for selectively producing one of two or more different predetermined lengths of successive sheets; and
the method further comprises operating the variable cut-off arrangement for producing one of the predetermined lengths of successive sheets.

40. The method of claim 39, wherein:
the primary and secondary lap rolls and the crossover roll all are rotatable about respective axes thereof, and the crossover roll axis is movable with respect to at least one of axes the primary and secondary lap rolls between at least a first position thereof corresponding to the first predetermined sheet length and a second position thereof corresponding to the second sheet length; and
the method further comprises, positioning the crossover roll axis at one of the first and second positions.

41. The method of claim 40, further comprising, positioning the crossover roll at the first position thereof for a first sheet length, and at the second position thereof for the second sheet length.

42. The method of claim 36, wherein, the sheet cutting and directing arrangement is also configured for operation alternatively in a multi-fold mode in which the sheet cutting and directing arrangement directs all of the successive sheets through the nip in a single stream of sheets with the successive sheets overlapped in a shingle-like orientation, and the method further comprises:
operating the cutting and directing arrangement in the multi-fold mode of operation to produce a multi-folded pattern of interfolded sheets.

43. The method of claim 42, wherein, the crossover roll is disengaged for operation in a first multi-fold mode of operation wherein all of the successive sheets are transferred from the knife roll to the primary lap roll to form a single stream of successive sheets entering the nip along only the first path and passing through the nip with successive sheets overlapped in a shingle-like manner to produce a first multi-folded pattern of interfolded sheets, and the method further comprises:
disengaging the crossover roll and operating the cutting and directing arrangement in the first multi-fold mode to produce a first multi-folded pattern of interfolded sheets.

44. The method of claim 43, wherein, the crossover roll is not disengaged for operation in a second multi-fold mode of operation wherein all of the successive sheets are transferred by the crossover roll from the knife roll to the secondary lap roll to form a single stream of successive sheets entering the nip along only the second path and passing through the nip with successive sheets overlapped in a shingle-like manner to produce a second multi-folded pattern of interfolded sheets, and the method further comprises:
operating the cutting and directing arrangement in the second multi-fold mode with the crossover roll engaged and configured to produce the second multi-folded pattern of interfolded sheets.

45. The method of claim 42, wherein, the sheet cutting and directing arrangement includes a variable cut-off arrangement for selectively producing one of two or more different predetermined lengths of successive sheets, and the method further comprises operating the variable cut-off arrangement to cut the single web of material into successive sheets having one of the predetermined lengths of the successive sheets.

46. The method of claim 36, wherein:
the sheet cutting and directing arrangement is operable in a zig-zag folding mode in which the sheet crossover arrangement is configured to direct successive sheets along only one of the first and second paths;
the sheet cutting and directing arrangement directs a length of the single web of material through the nip without cutting the length of web into successive sheets to form a zig-zag-fold pattern having the length of the single web of material folded to form a plurality of panels joined to one another along common fold lines disposed between adjacent panels; and
the method further comprises operating the sheet cutting and directing arrangement in the zig-zag folding mode to form the zig-zag folded pattern.

47. A folding apparatus for alternatively forming either a single-fold or a multi-fold pattern of interfolded sheets from a single web of material, the folding apparatus comprising:
a pair of counter-rotating folding rolls forming a nip therebetween for passage through the nip of at least one stream of the sheets for folding the sheets; and
a sheet cutting and directing arrangement for cutting and directing successive sheets cut from the single web of material through the nip between the folding rolls;
the sheet cutting and directing arrangement being configured for operation in a single-fold mode in which the sheet cutting and directing arrangement directs the successive sheets through the nip in two parallel streams of sheets;
the sheet cutting and directing arrangement also being configured for operation alternatively in a multi-fold mode in which the sheet cutting and directing arrangement directs the successive sheets through the nip in a single stream of sheets with the successive sheets overlapped in a shingle-like orientation.

48. The folding apparatus of claim 47, wherein, the sheet cutting and directing arrangement is further configured for operation in zig-zag-fold mode in which the sheet cutting and directing arrangement directs a length of the single web of material through the nip without cutting the length of web into successive sheets to form a zig-zag-fold pattern having the length of the single web of material folded to form a plurality of panels joined to one another along common fold lines disposed between adjacent panels.

49. The folding apparatus of claim 47, wherein, the sheet cutting and directing arrangement is further configured for operation in an alternate single-fold mode in which in which the sheet cutting and directing arrangement cuts and directs successive sheets cut from two webs of material through the nip in two parallel streams of sheets.

50. The folding apparatus of claim 49, wherein, the sheet cutting and directing arrangement is further configured for operation in zig-zag-fold mode in which the sheet cutting and directing arrangement directs a length of the single web of material through the nip without cutting the length of web into successive sheets to form a zig-zag-fold pattern having the length of the single web of material folded to form a plurality of panels joined to one another along common fold lines disposed between adjacent panels.

51. The interfolding apparatus of claim 47, wherein, the sheet cutting and directing arrangement is configured for operation in a first multi-fold mode of operation wherein all of the successive sheets are directed into a single stream of successive sheets entering the nip along only the first path and passing through the nip with successive sheets overlapped in a shingle-like manner to produce a first multi-folded pattern of interfolded sheets.

52. The folding apparatus of claim 51, wherein, the sheet cutting and directing arrangement is configured for operation of the sheet cutting and directing arrangement alternatively in a second multi-fold mode of operation wherein all of the successive sheets are directed into a single stream of successive sheets entering the nip along only the second path and passing through the nip with successive sheets overlapped in a shingle-like manner to produce a second multi-folded pattern of interfolded sheets.

53. The folding apparatus of claim 47, wherein, the sheet cutting and directing arrangement is configured for operation of the sheet cutting and directing arrangement alternatively in a multi-fold mode of operation wherein all of the successive sheets are directed into a single stream of successive sheets entering the nip along only the second path and passing through the nip with successive sheets overlapped in a shingle-like manner to produce the multi-folded pattern of interfolded sheets.

54. The folding apparatus of claim 47, wherein, the cutting and directing arrangement is configured for receiving a first and a second web of material and operation alternatively in a dual-web alternate single-fold mode for cutting and directing successive sheets cut from the first and second webs of material along first and second paths extending through the nip in the two parallel streams of sheets to produce the single-folded pattern of interfolded sheets.

55. A method for alternatively forming either a single-fold or a multi-fold pattern of interfolded sheets from a single web of material in a folding apparatus having a pair of counter-rotating folding rolls forming a nip therebetween for passage through the nip of at least one stream of the sheets for folding the sheets, the folding apparatus also having a sheet cutting and directing arrangement for cutting and directing successive sheets cut from the single web of material through the between the folding rolls, the method comprising:
operating the folding apparatus in a single-fold mode in which the sheet cutting and directing arrangement directs the successive sheets through the nip in two parallel streams of sheets to form the single-fold pattern of interfolded sheets; and
alternatively operating the folding apparatus in a multi-fold mode in which the sheet cutting and directing arrangement directs the successive sheets through the nip in a single stream of sheets with the successive sheets overlapped in a shingle-like orientation to form the multi-fold pattern of interfolded sheets.

56. The method of claim 55, wherein, the sheet cutting and directing arrangement is configured for operation in a first multi-fold mode of operation wherein all of the successive sheets are directed into a single stream of successive sheets entering the nip along only the first path and passing through the nip with successive sheets overlapped in a shingle-like manner to produce a first multi-folded pattern of interfolded sheets, and the method further comprises:
operating the cutting and directing arrangement in the first multi-fold mode to produce the first multi-folded pattern of interfolded sheets.

57. The method of claim 56, wherein, the sheet cutting and directing arrangement is configured for operation of the sheet cutting and directing arrangement alternatively in a second multi-fold mode of operation wherein all of the successive sheets are directed into a single stream of successive sheets entering the nip along only the second path and passing through the nip with successive sheets overlapped in a shingle-like manner to produce a second multi-folded pattern of interfolded sheets, and the method further comprises:
operating the cutting and directing arrangement in the second multi-fold mode to produce the second multi-folded pattern of interfolded sheets.

58. The method of claim 56, wherein, the sheet cutting and directing arrangement is configured for operation of the sheet cutting and directing arrangement alternatively in a multi-fold mode of operation wherein all of the successive sheets are directed into a single stream of successive sheets entering the nip along only the second path and passing through the nip with successive sheets overlapped in a shingle-like manner to produce the multi-folded pattern of interfolded sheets, and the method further comprises:
operating the cutting and directing arrangement in the multi-fold mode to produce the multi-folded pattern of interfolded sheets.

59. The method of claim 56, further comprising, alternatively operating the interfolding apparatus in a zig-zag-fold mode in which in which the sheet cutting and directing arrangement directs a length of the single web of material through the nip without cutting the length of web into successive sheets to form a zig-zag-fold pattern having the length of the single web of material folded to form a plurality of panels joined to one another along common fold lines disposed between adjacent panels.

60. The method of claim 55, further comprising, alternatively operating the interfolding apparatus of claim in a dual-web alternate single-fold mode in which in which the sheet cutting and directing arrangement cuts and directs successive sheets cut from two webs of material through the nip in the two parallel streams of sheets to form the single-folded pattern.
